(19) United States
(12) Patent Application Publication
(10) Pub. No.: US 2009/0261158 A1
(43) Pub. Date: Oct. 22, 2009

(54) AUTHENTICATION OF CHEQUES AND THE LIKE

(76) Inventor: Marcus Maxwell Lawson, Hampshire (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/278,384

(22) PCT Filed: Feb. 5, 2007
(86) PCT No.: PCT/GB07/00419

§ 371 Date: Sep. 4, 2008

(30) Foreign Application Priority Data
Feb. 6, 2006 (GB) 0602357.6

(51) Int. Cl. G07D 7/00

(52) U.S. Cl. 235/379

(57) ABSTRACT

Value based tokens are generated for inclusion on a data carrier which may be applied to a cheque or similar document. The tokens are generated by a core system, which communicates with application specific wrappers. The wrappers supply token parameters to the core that are specific to the application and the core generates the tokens, and stores them for later authentication. The core then encodes the tokens onto a data carrier under the control of the wrapper and distributes the tokens under the control of the wrapper. The tokens are encoded onto the cheque when it is printed. When a cheque is presented for authentication, for example by at a bank, the signed cheque is imaged and the token retrieved from the encoded data carrier. It is passed back to the core by the wrapper for authentication of its identification number and other parameters. The image may be sealed by a further data carrier which may be printed on the cheque or added to the electronic image. The further data carrier may include a separate token or have a token which is related to the first token. Where the data carrier is applied to the electronic image it may replace the first data carrier. The data stored on the carrier references cheque information stored at a database which is compared with cheque information retrieved from the cheque.

### FIELD OF THE INVENTION

This invention relates to the authentication of items such as cheques and the like.

### BACKGROUND TO THE INVENTION

Many techniques exist for increasing the security of financial papers such as money, cheques, travellers cheques etc. These involve a number of techniques including the use of magnetic inks using MICR (Magnetic Ink Character Recognition), OCR (Optical Character Recognition), and ICR (Intelligent Character Recognition, as well as Ultra Violet sensitive inks, microprinting, digital watermarking and other techniques. These known techniques are all useful for combating fraud which manifests itself in many ways. In the case of cheques, a bank must be able to satisfy itself that the underlying cheque is genuine and that the payee and amount have not been altered. Banks spend large amounts of money in securing cheques and preventing fraud. One common type of fraud is the theft of genuine cheques which are then used by the thief at the expense of the legitimate account holder. The techniques used to guard against this type of theft include the scanning of cheques to compare a digital representation of the signature to a stored version of the accounts holder's signature.

GB 2406690 of Neopost Industrie SA discloses a system for authenticating items such as a driver's license in which authentication information is stored in a data matrix. A data matrix is a 2-dimensional bar code. The data is cryptographically encoded in the data matrix and may be read by a processing unit which checks the validity of the item and transmits a message back to a presentation station indicating whether or not the item is valid. The data matrix may carry a digital signature. We have appreciated that the system described in this document is impractical as the data that is required to be stored in the data matrix exceeds the capacity of an acceptably sized data matrix. Even if the data matrix could be scaled to a different size it would not be robust enough to be read reliably. As coupons are used by customers and will often be folded or crumpled, a rugged, easy to read system is essential if the system is to be viable. Moreover, the system disclosed in GB 2 406 690 is only suitable for use in a closed environment in which only a single type of token is used and which is only to be read at a single verification point.

U.S. Pat. No. 6,611,598 of Unisys Corporation discloses the idea of placing a 2 dimensional bar code on a documents such as a cheque. The barcode includes details of the cheque payee and the amount and is useful to authenticate the completed cheque as being authentic. However, the barcode is only applied when the cheque has been completed and so the practical value of the system is confined to cheque users such as large corporations who have the ability to apply the barcodes to cheques they have written. It is also not useful in protecting the security of the cheque from the time it was first printed to being completed by a user. Thus, the system disclosed does not help protect against, for example, theft of cheque books when they enter the postal system from the printer to the account holder.

U.S. Pat. No. 5,491,325 of Huang et al discloses as system in which a bar code is applied to a cheque or other payment document and serves as an index to a corresponding data file which can be communicated to a drawee bank so that the bank has prior knowledge of information related to the cheque. This can be used to verify the authenticity of the cheque and the amount of the funds permitted. Once the cheque has been honoured, the corresponding data file is updated to show that the cheque is no longer live.

Another approach to cheque authentication is disclosed in WO01/41082 (Al Amri) in which cheques are provided with magnetic strips and/or chips which store information regarding the cheque. On presentation of the cheque this stored information can be read to verify the cheque and to compare information written on the cheque with the stored data. A similar approach is taken in WO97/24694 (VISA) in which a magnetic strip carries an encoded identifier of a travellers cheque and an equivalent object is stored in a central database. When the cheque is cashed the magnetic strip is read and the unique identifying code is verified against that stored at the central database.

### SUMMARY OF THE INVENTION

The present invention aims to provide an improved authentication system and method which addresses shortcomings of the prior art systems described above.

The present invention is not limited to the authentication of cheques but may be used to authenticate other financial papers such as travellers cheques, bank notes, etc. Moreover, the document may be authenticated when it is first created and then at various other stages throughout its life.

Embodiments of the invention have the advantage that the actual underlying document, such as the cheque is secured for authentication before the user adds details such as the payee and amount. This enables the cheque or other document to be authenticated throughout its life.

The invention is defined in the independent claims to which reference should be made.

In one aspect of the invention an imager produces images of completed cheques for storage in an image store. The image includes an image of a data carrier which includes an identifier. The identifier can be retrieved from the image and then compared against a stored identifier to authenticate the cheque. This has the advantage over prior art systems that authentication data is not lost during the imaging process. This is not possible with existing anticounterfeiting measures such as dyes, special inks and magnetic strip which are lost when the cheque is imaged.

The data carrier may be an RFID device or a 2-dimensional bar code such as a data matrix. Where a bar code is used, the applying means comprises a printer or other marking technology such as a laser.

Embodiments of this aspect of the invention also have the advantage that the cheque can be authenticated at any stage of its life and not just when it has been used by the account holder. The cheque related information encoded onto the graphical symbol relates to the cheque production information and may include information such as the cheque number and the account number and the date of printing of the cheque. This can be read at any time before or after the cheque has been used. Thus, for example, a cheque that has been stolen after it has been dispatched by the printers to the account holder can be identified.

In a second aspect of the invention, a cheque, once imaged, can be secured by applying to the electronic image a further graphical symbol having an identifier.

The further graphical symbol identifier may be linked to the unique identifier of the first graphical symbol and may contain information retrieved from a database by scanning the first graphical symbol to retrieve the unique identifier and retrieving the cheque related information stored at the database and referenced by that unique identifier.

The second graphical symbol may be printed on the cheque and the electronic image of the cheque may comprise the first and second graphical symbols. Alternatively,

the second graphical symbol may applied to the electronic image of the cheque after the cheque has been imaged. In the latter case, the second symbol may replace the first symbol as the symbol used for authentication.

Embodiments of the second aspect of the invention have the advantage that they enable security to be added to cheque truncation processes. When a cheque has been written by an account holder and has been presented to a bank to clear, an image of the completed cheque is formed and stored. In some jurisdictions, this image may become the legal representation of the cheque. This image can be secured with a second graphical symbol. This may have encoded content that is related to the first graphical symbol. Security is further enhanced if the content encoded on the second symbol is derived at least in part by authentication of the first symbol. The second symbol may be printed on the cheque before it is imaged or added to the electronic image file.

Embodiments of the various aspects of the invention have the advantage that the graphical symbol encoded with data to be authenticated can survive scanning of cheques performed by banks in cheque truncation processes. This enables the graphical symbol to be read, and the data encoded on it to be recovered after the cheques has been scanned. This greatly increases the security of the truncation process.

A further aspect of the invention includes a PIN in the token applied to the data carrier. This PIN may be used to lock the cheque so that it can only be cleared on production of the correct PIN. The PIN may even be specific to a particular bank at which the cheque is to be present to be cleared. The PIN may be used to identify the issuing organisation or a person authorised within that organisation to issue cheques. The party responsible for authenticating the cheque may retrieve the PIN and check that it is valid before continuing the authentication process. Where the PIN relates to an individual, the PIN may be checked against the identity of that individual either carried on the body of the cheque or encoded into the data carrier. In one aspect, the authorising party has a specimen signature stored for each PIN number and the authentication process includes imaging the signature on the completed cheque, retrieving the PIN and retrieving the stored signature for that PIN. The two signatures can then be compared and authorisation can only continue if they match. This aspect has the advantage of greatly reducing the processing required for automated signature checking, making it commercially viable. It is of particular advantage in the authorisation of high value cheques but may be used for cheques of any value.

### BRIEF DESCRIPTION OF DRAWINGS

Embodiments of the invention will now be described, with reference to the accompanying drawings, in which:

FIG. 1 is a view of a data matrix;

FIG. 2 is a schematic diagram of the core and wrapper of a system embodying the present invention;

FIG. 3 shows how the core of FIG. 2 may be used with a plurality of different application wrappers;

FIG. 4 is a schematic representation of the functionality of the system;

FIG. 5 is a representation of the software components of the core of the system of FIG. 2 providing the functionality of FIG. 4;

FIG. 6 is a representation of the functionality of the delivery manager of FIG. 5;

FIG. 7 shows the structure of a value based token embodying the invention;

FIGS. 8 and 9 show, respectively, embodiments using data lite and data heavy value based tokens;

FIGS. 10 and 11, respectively, show VBTs having intermediate amounts of data in the token;

FIG. 12 is a schematic diagram showing cryptographic functions;

FIG. 13; is a schematic diagram showing the life cycle of a value based token;

FIG. 14 shows how a system embodying the present invention may be integrated into existing customer systems; and

FIG. 15 is a schematic view of how an embodiment of the present invention may be used to authenticate cheques; and

FIGS. 16 and 17 show how the authentication system may be incorporated in a cheque clearing system.

### DESCRIPTION OF EMBODIMENTS OF THE INVENTION

The system to be described provides a secure, web service based, authentication system for printed and other media types using data carriers such as Data Matrices and RFID. The system has a core generic part, which includes components that support generic functional requirements. The core components are extended on an application by application basis, or customer-by-customer to support specific industry requirements. These specific extensions are referred to as “wrappers”. The system is not limited to the Internet or World Wide Web but may be implemented on any type of network, for example a company private network. In many applications, embodiments of the invention will interface with existing networks of a user or set of users.

The system to be described may be used in a variety of different applications. The following are given as examples only.

Banking: Adding a value-based token to cheques (for example, when a cheque is personalised during production by the bank and is printed). This can then be used within the banking environment to validate cheque details during the clearing process to reduce fraud.

Ticketing: Creating tickets as value-based tokens and delivering them via various channels: postal, email, mobile etc. This allows secure authentication and redemption of tickets at the point they are presented.

It is stressed that these are only a few of the many applications of the embodiments to be described and are given by way of example only. The concept of a value-based token (VBT) is discussed here briefly. A fuller description is given below. A VBT is a mechanism that allows a unique entity to be created, printed (or delivered via another channel) and subsequently authenticated. All VBTs have a unique identity, the ability to store data and security features to prevent their content and structure being amended maliciously. For example, a VBT may contain a unique token number, details about the product or document to which the VBT is to be affixed and a message authentication code (MAC) used to identify if a token has been altered.

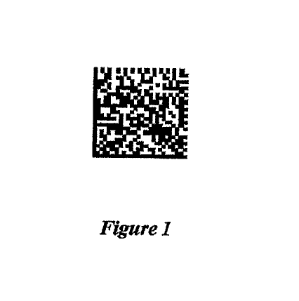

The preferred data carrier for the VBT is the Data Matrix (DMx). However, other data carriers may be used depending on the nature of the VBT and the data to be carried, and the geographical region in which the solution is to be implemented. The nature of the data carrier is described in detail below. Data Matrix is an encoding standard used to produce a 2-D barcode such as the one show in FIG. 1. It can be included in a document, on some other form of printed media or could even be applied to a product itself. At some point in the VBTs life it will be read (scanned) and then authenticated and/or redeemed by the system depending on the appropriate token life cycle.

A Data Matrix encodes information digitally in the form of a checker pattern of on/off. Data Matrix is defined by ISO standard, ISO/IEC16022-International Symbology Specification, Data Matrix.

It is possible, in some embodiments of the invention, that the VBT will never be printed, for example if it remains in electronic form. In such a case, the VBT may not need to be encoded on a data carrier.

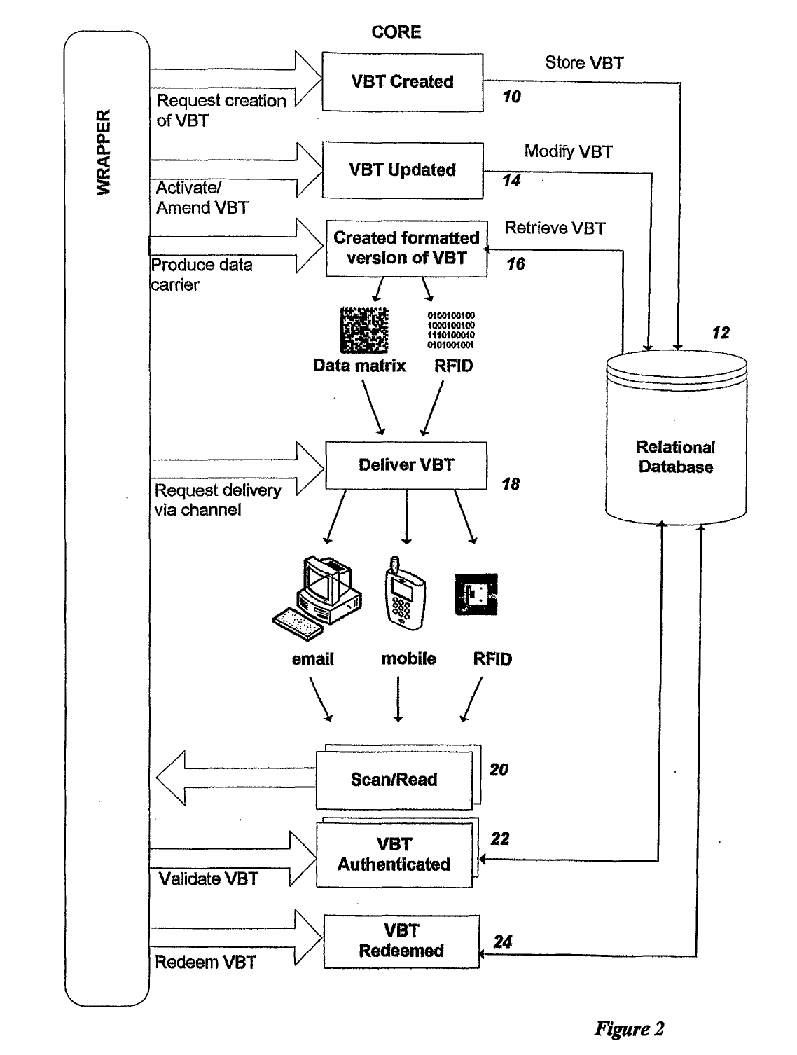

FIG. 2 provides an overview of the interaction between a wrapper (industry implementation) and the core. The core includes a database, for example an Oracle 10 g database which holds data to be included in the VBT and data which is related to data held in the VBT, as discussed below. The core is responsible for creation, updating and delivery of VBTs as well as the creation of formatted versions of VBT for inclusion on the selected data carrier. The core is also responsible for the processing of scanned data carriers to authenticate them and to update the database to show that a given VBT has been redeemed. The wrapper holds information that is specific to an application so that, for example, where the data carrier is applied to a coupon, the wrapper will hold information that is specific to that application, such as the data structure of the VBT, the type of encryption used and the data carrier into which the VBT is to be formatted. This approach makes is simple to adapt the system to new applications for the VBT.

The various functions of the core shown in FIG. 2 will now be described in more detail.

Creation 10: During token creation, the core creates a unique identity for the VBT and stores it in the token repository (database 12). A VBT will carry data relevant to its application although it is not a data store in itself. For example, a VBT used to secure a cheque may contain the payee, account and amount. The wrapper is responsible for passing all application specific data to the core. Each type of VBT will have specific security requirements defined in a security policy. For example, a simple voucher may only need a message authentication code to prevent data being changed whereas a bank cheque may require encryption and a digital signature. The core will apply these security features automatically during creation. The structure of the VBT is discussed below.

Update 14: A wrapper may need to update a token during its life cycle, usually to change its status. The core allows updates providing they do not violate the rules defined for the token type, e.g. a wrapper can change the token status from ‘created’ to ‘active’.

Format for data carrier 16: A wrapper can request that a VBT is built for a particular data carrier, for example a Data Matrix or RFID. The core chooses the appropriate software application for the data carrier and uses it to construct a VBT of this type. New providers can be plugged in to the core and configured for use via an administration interface.

Deliver 18: The core allows a wrapper to send tokens via supported channels. Messages sent via the core can use generic XSLT templates to format messages. Alternatively, a wrapper can construct a message itself and simply send it via the core. Messages may be delivered via email. Additional channels may require access to third party messaging gateways for example, to send SMS messages.

Read VBT 20: A VBT will be scanned/read at the point of use, for example a bank or a retail outlet. The content of the VBT can be used locally if required. However, to authenticate or redeem the VBT the content will be securely sent via the wrapper, e.g. a web service call. The wrapper can apply custom validation, business logic before using the core to authenticate and/or redeem the VBT.

Authenticate 22: The wrapper will pass the entire content of the VBT to the core for authentication. During this process the VBTs security features are used to validate its authenticity, i.e. PIN, MAC and signature. Where a VBT contains encrypted data the core will decrypt and return the clear text to the wrapper where additional processing can be performed.

Redeem 24: The wrapper will pass the entire content of the VBT to the core for redemption. The VBT will be checked by the core to ensure it is valid and if successful will update the VBT to a redeemed status. VBTs will normally be redeemed only once; however the core will allow tokens to be configured to allow multi-redemption of a single VBT. This may be required in some applications, where, for example, the VBT relates to a multiple entrance pass for a venue.

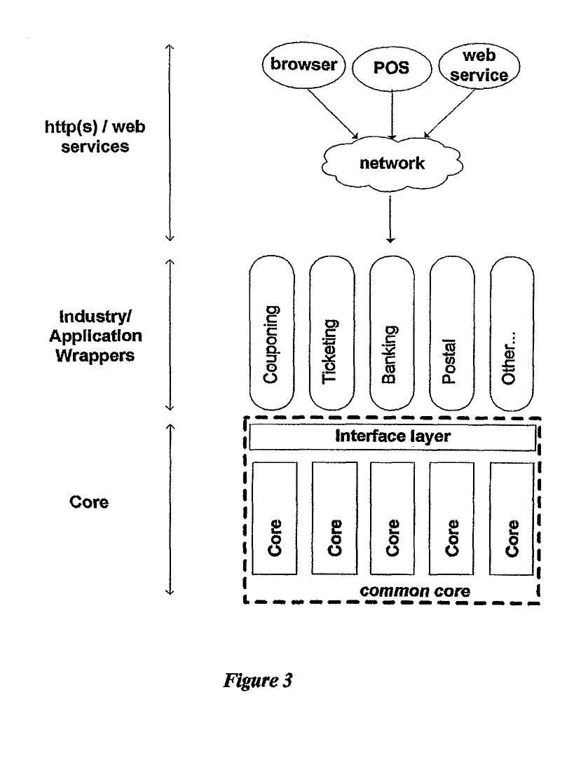

A typical deployment will include the core extended with a wrapper, which is a customisation for a specific application). FIG. 3 shows several deployments, each with their own wrapper. The wrapper may extend the core to implement additional data requirements, additional validation/business logic, customize the look & feel and provide a user web portal. In FIG. 3 examples of wrappers for couponing, ticketing, banking and postal applications are shown.

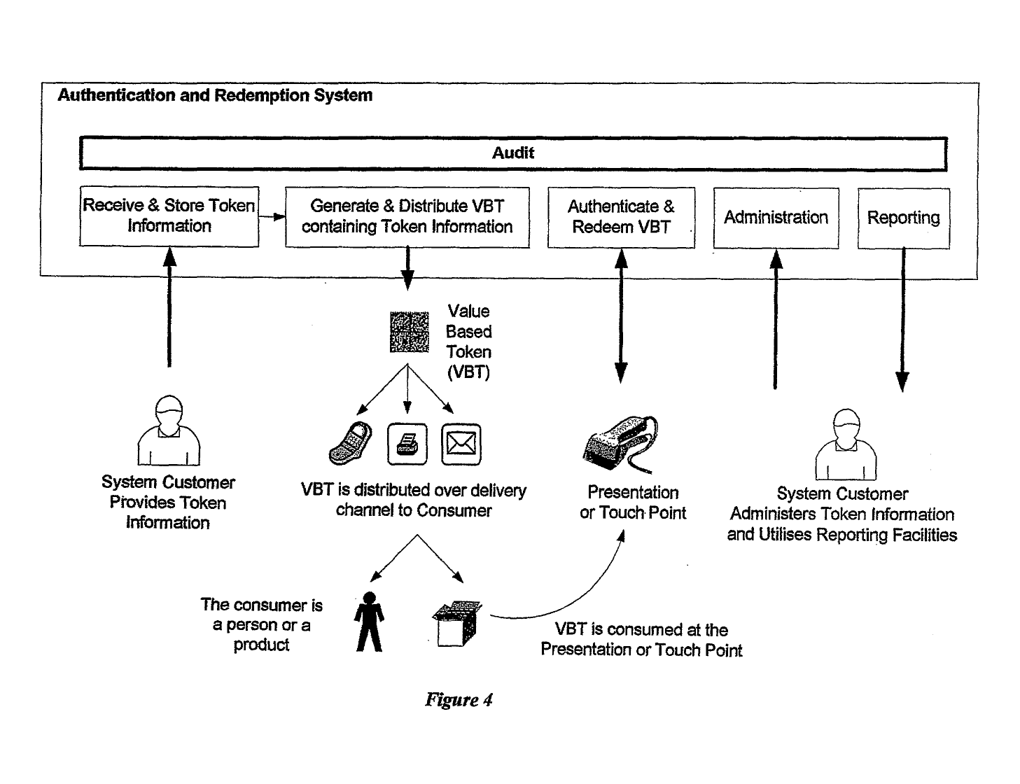

FIG. 4 shows the outline functionality of the system. There are five basic modules which are described in detail in relation to FIG. 5 below: Audit, Receive and Store Token Information; Generate and Distribute Value-based-token (VBT) containing Token Information; Authenticate and Redeem VBT; Administration; and Reporting. The receive and store token information module receives token information from customers who provide details of the data that is to be included in the token. For example if the token represented a money-off token, the identity of the token as a money-off coupon, and the token value, the product to which it relates and other parameters are supplied by the customer via a wrapper for that token type, as is described below. The generate and distribute module takes the token information and forms it into a value-based-token having a structure described below and then encodes the VBT onto a data carrier. The data carrier is then distributed to consumers over any convenient delivery channel such as, but not limited to, the postal services, email, fax, commercial print works and web-based distribution. The consumer is a person or even a product. The VBT may be applied to a coupon or the like that a person can redeem or may be applied to a product such a labelling or packaging. The authenticate and redeem module is responsible for verification of the authenticity of a VBT bearing data carrier when it is presented. The data carrier will be scanned and the encoded VBT recovered and verified by the system in a manner to be described. Finally the administration and reporting modules allow customers to interact with the system to provide them with selected information about the generation, authentication, and redemption of tokens by the system in accordance with their level of permissions.

FIG. 5 illustrates the software components that comprise the core. The core supports Internet and Intranet access via a browser which is also used to access the core administration interface and web service calls to APIs. Components are built using a J2EE development framework.

The following processes form part of the core solution. Each wrapper may use all or a subset of these processes to deliver the most appropriate solution

### User Account Creation

### User Account Maintenance

### Login/Logout and Session Management

Key management

### Token Creation

### Token Maintenance

Token Generation (format VBT for data carrier, e.g. data matrix)

### Token Encryption

### Multi-channel Token Delivery

### Token Authentication

### Token Redemption

### Multiple Token Redemption

### Token Batch Creation and Management

Unique Token ID generation

### Token History Reporting

### Audit Reporting

### Token Manager

The Token Manager component supports the creation and maintenance of VBTs within the core repository. It does not include any authentication or redemption functionality to provide additional security and deployment options. The token manager provides for creation of a unique entry in the core repository representing a VBT; maintenance of a history of all token events, e.g. creation, update etc. The token manager can specify an optional free text payload that will be contained within in the generated token. For example, this payload would be written to a data matrix or written to an RFID chip. This payload is referred to as the embedded payload.

The token manager can also specify an optional free text payload that is stored in the database. This payload is referred to as the additional payload. This payload will not be included when the token is generated. Additional payloads can be retrieved when a token is authenticated or redeemed. The token manager controls updating of a token's additional payload. A token can only have one additional and one embedded payload. A token's embedded payload cannot be updated unless it is in created status. If it has any another status it may already have been delivered, e.g. printed, and the delivered content cannot be amended. The token manager can specify an optional pin/password to secure a token. It is also responsible for activation and cancellation of tokens. Prior to activation any attempt to authenticate or redeem a token will fail. A token is only valid between its start and end dates. These dates include a time element. The token manager can create tokens for different data carriers.

A token's security features, such as whether it contains a digital signature, are defined in a security policy. The following combinations of token, wrapper (payload) and security data may be supported:

### Token

### Token+Payload

### Token+Payload+MAC

### Token+Payload+Digital Signature

The payload can be clear text or encrypted depending on the application. Every token event (creation, update etc) can be audited and a token batch can be created and used as a logical grouping of tokens. A batch includes a meaningful name. A token may be assigned to an existing batch.

The core supports an extensible token lifecycle so that new statuses and the valid transitions between statuses can be defined. The token manager can also redeliver an existing token, for example, if the original has been lost. The operation of the token manager will be better understood from the following use cases.
Use Case Name: Create Token
Actor/Role: Wrapper
Description: Create VBT entries within the repository
Pre-Conditions Wrapper is authenticated and authorised to use the service. Where a batch is specified the batch must already be created.

### Flow:

1. Wrapper sends token details to the Token Manager component. As a minimum the token type is required. Other optional attributes include:

PIN Security code required when using token.
Payloads Data to be carried with the token.
Start date Date from which the token can be used.
End date Date at which the token expires.
Status Status to be assigned after creation.
Redemption Limit Max times VBT can be redeemed (default 1)
Batch Identifier Batch token should be assigned to.

2. Validate that the token type is available for the current service.

3. Validate token details. The PIN preferably has an alphanumeric value up to 30 characters in length. If an additional payload has been specified, i.e. it will be held in the database, the token type must be validated to confirm this type of payload is supported. If a status other than ‘created’ has been specified it must be a valid transition from ‘created. The batch must exist.

4. Generate token identification number [TIN]. This will be generated via the Security Manager that provides random number generation. The TIN may, for example be of fixed length such as 16 digit numbers for the TIN. However it is preferred that the TIN length is configurable as this further increase the flexibility of the system.

5. Generate token key. This value is also generated using the Security Manager's random number generator. This is a unique internal key for the token which will be used when referencing the token externally, e.g. from an email. As the key is not embedded within the token it is more difficult for malicious users to obtain.

6. Retrieve the security profile for this service/token. This will determine how the token should be constructed. The security profile will include:

Hash Hash/HMAC function used for MAC
Signature Cipher used for digital signature
Encryption Cipher used for encryption
Method Describes which security features to use.

7. Apply security policy to generate VBT string. If required, calculate the message digest of the token header and payload using the Security Manager. One suitable standard is HMAC-SHA256.

If required, calculate the digital signature of the token using the Security Manager. One suitable standard is RSA-SHA256.

8. Create token and its payload(s) within the repository.

9. Create a token history record containing all the token details.

10. Write an audit record of type ‘TOKEN_CREATION’ for the event.

11. Return the TIN to the wrapper

### Use Case Name: Update Token

### Actor/Role: Wrapper

Description: Amend VBT details (e.g. setting status to ‘active’)
Pre-Conditions: Wrapper is authenticated and authorised to use the service.
Where a batch is specified the batch must already be created.

### Flow:

1. Wrapper sends token details to the Token Manager component. In addition to the TIN the attributes may include:

PIN Security code required when using token.
Payloads Data to be carried with the token.
Start date Date from which the token can be used.
End date Date at which the token expires.
Status Status to be assigned after creation.
Redemption Limit Max times VBT can be redeemed (default 1)
Batch Identifier Batch token should be assigned to.

2. In addition to the validation checks performed for these attributes in the ‘create token’ use-case the following checks should be performed. The embedded payload can only be updated if the token has a status of created. If a new status is specified it must be a valid and current transition as defined in the Token Management component.

3. Re-apply security policy to generate VBT string.

4. Update the token and payload (if amended) within the repository.

5. Create a token history entry in the repository.

6. Write an audit record of type ‘TOKEN_UPDATE’.

### Use Case Name: Generate Token

### Actor/Role: Wrapper

Description: Generate a VBT for specific data carrier (e.g. data matrix)
Pre-Conditions: Wrapper is authenticated and authorised to use the service

### Flow:

1. Wrapper sends request to the Token Manager. The TIN will be specified to identify the token. The wrapper may also use the attribute: Data Carrier. In a preferred embodiment, two data carriers are supported:

→ Text: Simply returns the raw VBT string.
→ Data Matrix Encodes the VBT string using data matrix symbology.

2. Validate the TIN and Data Carrier.

3. Retrieve the provider (class responsible for encoding the VBT string) for the data carrier.

4. Encode the VBT string for the requested data carrier. For example, where the data carrier is data matrix a 2-D barcode will be generated using the data matrix image or font generator.

5. Return encoded VBT to the wrapper.

6. Write an audit record of type ‘TOKEN_GENERATE’.

### Use Case Name: Create Batch

### Actor/Role: Wrapper

Description: Create a batch (logical container for VBTs)
Pre-Conditions: Wrapper is authenticated and authorised to use the service.

### Flow:

1. Wrapper sends request to the Token Manager component. An optional batch description can be specified.

2. A batch is created with a unique identifier.

3. Return batch identifier to the wrapper.

### Token Manager API

The following Java API's will be exposed to wrapper modules. The APIs are built to allow new commands to be added as required without altering any existing API calls.

createToken—Create a token as per the use-case described above.

updateToken—Update an existing token subject to the use-case describes above.

generateToken—Encode the token into a Data Matrix or other token formats such as RFID.

createBatch—Creates a new batch in the token repository and returns its ID to the calling module.

### Authenticate

The authentication component is responsible for authentication of tokens when they are read or scanned.

If a token has been signed the signature must be validated during authentication. An invalid signature will result in authentication failure. If a token contains a MAC this must be validated during authentication. An invalid MAC will result in authentication failure. During authentication a check is performed to confirm that the token exists within the repository. A missing token will result in authentication failure. During authentication the token's start and end date must be checked together with its status. When a status is defined it will be assigned a flag that identifies whether it will cause authentication to succeed or fail. For example, a status of ‘created’ may cause authentication to fail and a status of ‘active’ may result in success. If a token has been secured with a PIN, the PIN should be supplied and checked as part of the authentication process. If the supplied PIN does not match the original value the authentication process will fail. The PIN may advantageously be used in a number of ways as will is discussed below.

On successful authentication or redemption the additional payload is returned (if requested).

All authentication requests successful or otherwise should be audited. The manner in which the authentication component operates will be understood better from the following use cases.

### Use Case Name: Authenticate Token

### Actor/Role: Wrapper/Web Service

### Description: Verify Token Details

Pre-Conditions: Actor is authenticated and authorised to use the service.

### Flow:

1. Wrapper sends token content to the Authenticate component. It also specifies whether the additional content should be returned on successful authentication and any PIN details specified by the user.

2. Retrieve the security profile for this service/token type using the service management component. This must be the policy in place at the time the token was created.

3. If a PIN is required to use the token the PIN value supplied must be processed to ensure it matches the PIN digest stored in the repository.

4. If the security policy specifies a digital signature use the Security Manager to validate the signature. If the signature is invalid return an authentication failure status.

5. If the security policy specifies a hashing algorithm use the Security Manager to validate the message digest. If the message digest is invalid return an authentication failure status.

6. Confirm the token exists in the repository and that its status contains a valid ‘authenticate’ flag.

7. Validate the tokens start and end dates.

8. If a token's redemption count must be less than its redemption limit (the maximum number of times it can be redeemed).

9. If all the above steps have passed the validation process returns a valid status to the actor and the additional payload (if requested)

10. Write an audit record of type ‘TOKEN_AUTHENICATE’.

### Authentication API

The following Java APIs support the authentication use-case above. Although a default authentication Web Service is part of the core most wrappers extend the authentication process. In this case the Java APIs can be used to support the requirements of their redemption process.

authenticateToken—using the security features on the token, this API verifies that the token is genuine and has not been tampered with.

authenticatePIN—compare the PIN stored against a token with a user supplied value.

### Authentication Web Services

AuthenticateToken—this service supports the authentication process defined in the above use-case. If the service consumer requests the token's additional payload it is returned only on successful authentication.

### Redemption

This component is concerned with redeeming tokens after they have been authenticated.

Before redeeming a token it must pass all token authentication tests. A token can only be redeemed if it has a status is flagged as ‘redeemable’. For example, the token statuses ‘created’, pending’, ‘approved’ and ‘redeemed’ may be defined and tokens may only be redeemed in they have a status of ‘approved’. A token can be redeemed more than once, with the maximum number of times a token can be used being defined for a token at its creation. By default a token can only be redeemed once.

All attempts to redeem a token are written to an audit log, and when successfully redeemed a token's status is updated to ‘REDEEMED’ (or to a specific status).

The operation of the redemption component is further explained by the following use case.

### Use Case Name: Redeem Token

### Actor/Role Wrapper/Web Service

Description: Amend token details (e.g. setting status to ‘active’)
Pre-Conditions: Actor is authenticated and authorised to use the service

### Flow:

1. Actor sends token content to the redemption service including any PIN details specified by the user.

2. Token is fully authenticated as per the Authenticate Token use-case. If authentication fails a failure response is returned to the Actor.

3. Token status is updated to ‘redeemed’ (or to whatever status the actor has requested, subject to transition rules).

4. Increment the redemption count.

5. Write the transaction to the audit log.

6. Return the redeemed payload to the Actor.

### Redemption API

The following Java APIs support the redemption use-case above. These can be extended to support a custom redemption process.

redeemToken—Redeem the token as per the use-case defined above.

### Redemption Web Services

RedeemToken—this service supports the redemption process in the above use-case. On success the redeemed payload is returned.

### Identity Management

This component only manages basic account information. This includes a ‘display name’ that may be used for reporting purposes and default values for e-mail address and/or mobile that can be held as default values for the appropriate delivery channels. Users of the system authenticate themselves using a username/password. Calls to service based functions (web services) can authenticate via username/password or Certificate Based Authentication (x509.3). An administrator may register new users via a User Interface (UI)

### Identity Management API

The following Java APIs are exposed to the wrappers.

authenticateUser—authenticate a user's credentials and create a new session.

isSessionValid—returns true if the current session is still valid.

getSession—returns the current session which can be used to identify the user's account and other session details.

maintainAccount—create and maintain user account details.

hasRole—returns true if the current session has been assigned a particular role.

### Identity Management UI

The following user interfaces are provided for the identity management component.

Login—Basic login screen. Username/password authentication.

Error Page—A generic error page used to display authentication, page access and general error messages.

User Registration—This screen allows administrators to create accounts for new users and assign them an appropriate role.

### Reporting

The reporting component is responsible for the reporting functionality.

Reports will be called from the administration screens and provide flexible reporting based on audit records written by the core components. Redemption reporting can report on both successful and unsuccessful redemption attempts. Successful redemption records include the date/time stamp, account, token type and optional location id if provided by the web service. Failed redemption attempts include date/time stamp, account, token type, optional location id if provided by the web service and information about the reason for the failure. Each token listed in the redemption report provides drill down functionality to get further information about the token. Reports can summarise the status of all tokens or a subset of the tokens as defined by parameters provided to the report. This report accepts dates, service and token type as parameters. A status summary report provides a drill down to get further information about the tokens in each status. A token report by status lists all the tokens in the given status that fall within the parameters passed to the summary report. It is possible to drill down on each token. The complete history of a token can be reported and a status summary report is available to report on the tokens associated with a batch.

The core reporting functionality does not include management information in the preferred embodiment. This is implemented on a wrapper-specific basis. The reporting included as part of the core falls into the following categories:

### Audit Reporting

### Redemption Reporting

### Token Reporting

The audit reporting provides parameterised reports on the application audit table. This report may be parameterised based on a date or date range, the service, the audit level or the audit type. Each of these parameters is optional. The redemption report provides information about successful redemptions and those that have failed. The redemption report may be parameterised based on the service, a date or date range and the token type. The report provides detail about the account and a ‘location id’ if provided by the web service. The failure report also includes any error codes that will provide further information about the reason for failure.

The token report lists a summary by status of all tokens within the system. This report has optional parameters of service, token type and date or date range. The token report by status provides information about the date the token was updated to the selected status and the account that requested the update. Each token will link to a token history report.

The token history report provides information on each status transition that the token has made. It will also report on the accounts that requested the transition, the date and any additional details that may have been supplied e.g. delivery channel, error code or location id. This report will include both successful transitions and transitions that have failed.

It will be appreciated that the reporting functionality available is highly advantageous as it allow tracking of tokens by the token creator. This may, for example, be the issuer of a money-off coupon who wants to track how many coupons have been issued and redeemed.

### Audit Manager

The audit manager component handles audit requests. The core allows custom audit types to be defined (for use in a wrapper). Audit requests include an audit level. This allows the audit component to be configured to only record events within an audit threshold. All events associated with a token are audited and written to a token history. It is also possible to add a cryptographic seal to audit records, e.g. a digital signature produced using HSM, to provide evidence if the content of the audit record is modified.

Within the core components there are two types of auditing: Core Application Auditing and Token Auditing. The core application auditing allows audit records to be written for a range of actions. The actions that are audited are controlled at a service level. Each piece of audit information is categorised according to the Audit Type e.g. Login, UpdateReferenceData. Each Audit Type has an associated audit level. The level of audit required is associated with the service within the application reference data. Before an audit statement is written a check is made to see whether the audit record to be written has an audit level less than or equal to that defined for the service. Any audit record with an audit level in the correct range will be written to the audit table.

Each Audit Record will include the following information:

A date/timestamp indicating when the record was written;

Information showing the type of audit record that is being written and the audit level assigned to that information;

The service that the audit record has been written for;

An optional message—to store non-standard details;

Information about the account that triggered the writing of the audit record—this will always populated unless the audit record is for something like a failed log in.

A separate table is populated to support the token auditing requirements within the core application. Each time a token is created or a change is made to an existing table. A record is written to a table that records information about changes made to the tokens. This provides a complete history of the token life cycle for each individual token.

Each Token History Record includes the following information:

The id associated with the token that has been created or updated;

The account that created or updated the token;

A date/timestamp indicating when the record was written;

A short description from a list of allowable values that will describe why the record was written;

A flag indicating whether the record has been written after a successful update or a failure;

Any error codes returned by the application will also be included in the token history record if the creation/update of the token was a failure;

If an activate call is made the delivery method and detail values are populated to record the route via which the token was delivered;

If the validity dates of the token are changed the new dates will be recorded in the history record.

If an authentication or redemption web service call is received that includes information about the location where the web service has been called from e.g. a till id/store id/merchant id this is stored in the history record.

### Audit Manager API

writeAudit—create an application audit record.

The core and wrappers can create data that is auditable to the highest standards. This allows the system to provide non-repudiable data. This ability is integral to the reporting linked to unique identities represented by the TINs and their authentication path. It means that value based transactions can be safely performed whether the value is monetary or otherwise. However with true audit level data sitting behind the normal reporting modules, linked to the client's wrapper behind it) “transactional monetary Properties” can be safely associated with it. Therefore when an authentication and redemption of a VBT representing a coupon, ticket, voucher note etc is done it can be linked to a real monetary transaction such as a micro payment or some other form of banking system like money transfer. This gives clients the ability to do financial reconciliation in real time if they require. The level of security and trust in the entire system allows a client to make real financial links and account in the true sense. Thus the presence of non-repudiable data is highly advantageous. One aspect of non-repudiation is time of creation. Reliance on system time is not sufficient as it can be manipulated. Embodiments of the present invention enable a non-repudiable time stamp to be applied to VBTs which can be relied on.

### Security Manager

This component handles security within the core and preferably uses the Public Key Infrastructure (PKI). PKI is a set of technologies, standards and procedures that define an enterprise-level security infrastructure. Components of PKI include:

Secret (symmetric) keys
Public and Private Keys (asymmetric keys or KeyPairs)
Digital Signatures, which use Hashing algorithms and Message Digests
All cryptographic functionality may be implemented using the Java Cryptography Architecture (JCA) and Java Cryptography Extensions (JCE) APIs.

The security manager seals tokens with a MAC which can be validated by the core. A digital signature can be created for a token using a service's private key and can be validated by the core. The content of a token can be encrypted using a service's private key and the content can be decrypted. The core supports generation of true random numbers, e.g. to produce token Ids, and stores a token's credentials (PIN/password) securely, e.g. using cryptography to store a message digest generated from the credentials.

### Security Manager API

The following security commands will be provided via a java API. The API is built to allow new commands to be added as required without altering any existing API calls.

createMAC—creates a message authentication code using the key/algorithm defined for the service/token type.

validateMAC—validate a token's MAC using the key/algorithm defined for the service/token type.

encrypt—encrypt data using the key and cipher defined for the service/token type.

decrypt—encrypt data using the key and cipher defined for the service/token type.

createsignature—create a digital signature using the private key and cipher defined for the service/token

validatesignature—validate a token's signature.

createMessageDigest—create a message digest using a specified hashing function, e.g. to create a PIN hash.

generateTRN—generates a true random number.

applySecurity—apply a security policy to a VBT.

### Delivery Manager

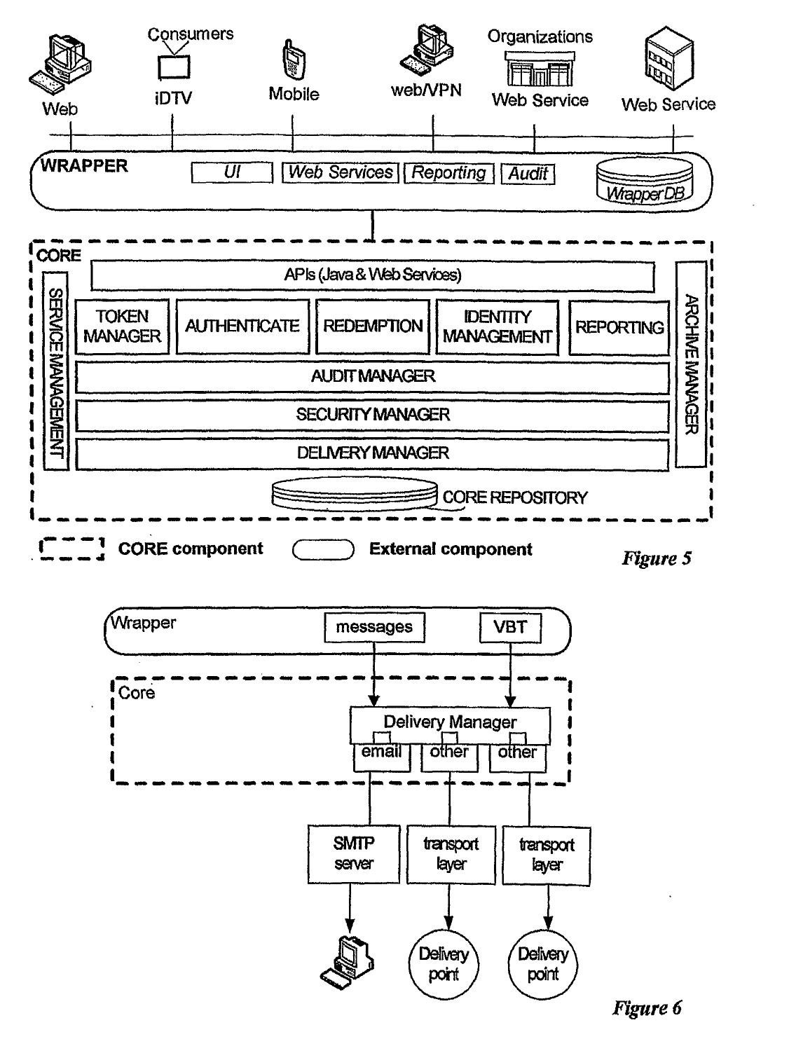

The delivery manager enables messages (which may include a VBT) to be sent via different channels. The delivery manager is an extensible component allowing support for new channels to be developed and plugged in without modifying the interface between the wrappers and core and is shown in FIG. 6.

The core supports multi-channel delivery of VBTs which may, for example, include email delivery. A message template may be defined that will be used to deliver a token via a specific channel. Whenever a token is sent via the delivery service an audit record is written.

### Delivery Manager API

SendMessage—delivers a token via a specified channel using a template defined for the service/token type.

### Service Management

The token management component allows an administrator to create and maintain the reference data associated with a token. An administrator may create a service via a user interface (UI). The Service Management UI enables an administrator to assign supported token types to service, and to create and maintain service roles. The administrator can create and maintain token statuses and configure tokens to enable or disable the use of additional payloads. A token status indicates whether redemption is possible and also indicates whether a token would pass authentication in this state. An operator may update token details in a batch, i.e. the same change is applied to multiple tokens for example, activating all the tokens in a batch. The core can support an extensible token lifecycle, making it possible to define new statuses and the valid transitions between statuses.

As there are a number of tables that need to be populated in order to configure the core components, there is a requirement to provide administration functionality to support updates to these tables. Administration functions and screens are only required for tables where the account holders or administrative account holders need to be able to make updates. A range of administrative functions is required to manage accounts within the core components. These functions allow for the creation of accounts and account maintenance. Whether these provide “self service” functionality or “administrator-only” functionality is determined at a wrapper level by the implementation of appropriate account types.

These functions maintain the tables within the core component schema and also the basic information that will be held in the LDAP directory to support login functionality. All administrative changes that are made by application screens are audited using the appropriate audit types so that a full history of the changes made and the actioning accounts is maintained.

### Service Management UI

Administration Screens may provide for the following:

Service Configuration—this screen allows administrative users to update the audit_level, error_level and audit_method of the service. The service information screen also allows the security policy associated with the service to be updated.

Communication Templates—the screen allows templates (e.g. an email template) to be created and updated by users with the appropriate permissions. Service/Account Mapping—a screen and/or API is provided to add new accounts to the appropriate service. An account must also be assigned an account type for each service to define the level of access the account holder has. The administration screen also allows for updates to the account type.

Account Types—A screen is provided to create account types and associate them with the appropriate roles to define their usage of the core components. The screen also allows administrative users to maintain the roles associated with account types.

Audit Types—A screen is provided to maintain the audit types available within the system in case any of the audit levels need updating.

Service Delivery Options—A screen is provided to maintain the delivery options that are available on a service-by-service basis. This screen will enable administrative users to switch delivery options on and off for the appropriate service.

Token Statuses—this screen allows administrative users to create and maintain token statuses.

Token Status Transitions—this screen allows administrative users to define valid transitions between token statuses.

Security Policy—this screen allows administrative users to define and maintain token security policies. These policies define the security

Update Token—Maintain existing token details, e.g. change status, end date etc. requirements used during token generation, e.g. should a digital signature be created, using which algorithm.

Reporting—menu access to the reporting homepage

The database used in the core may be any suitable database such as an Oracle 10 g database.

The structure of the value based token (VBT) will now be described in more detail.

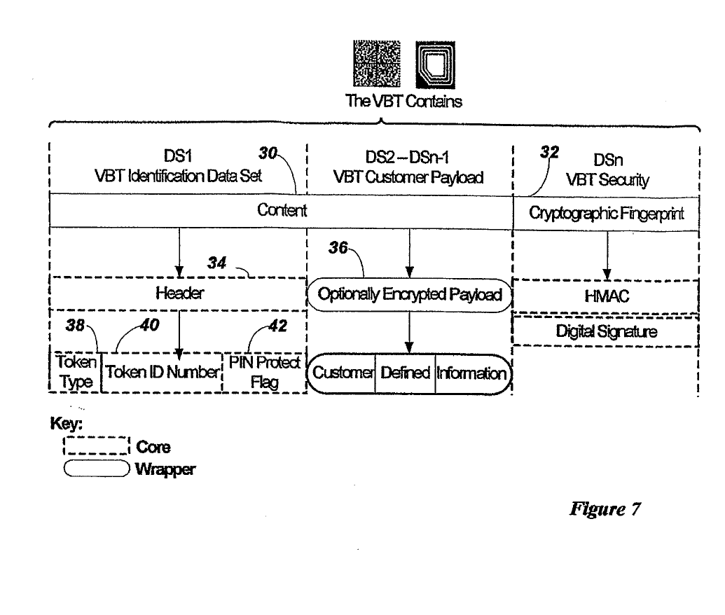

FIG. 7 shows the structure of the VBT. The token contains a contents portion 30 and a security portion 32. The contents portion 10 is divided into a header portion 34 and a payload portion 36. The header comprises a first data set DS1, and the payload contains a number of further data sets DS2-DSn-1. The security portion comprises a further data set DSn. Typically the header will contain a data set having at least three sub-data sets. The first 38 identifies the type of token. This is required in any open system in which the token could represent a number of different things such as an identifier for a medical prescription or an identifier for virtual money. The Token type data set identifies the nature of the token. The second data sub-set is a Token Identification Number (TIN) 40. The TIN is a unique number that identifies a particular token. The Third data sub-set is a PIN (Personal Identity Number) 42 and comprises a flag. Depending whether this flag is set on or off, the person presenting the token for redemption will be required to validate the token with their PIN number which will be compared with a number stored in the data set 42. The header section appears in all tokens whatever their application. It uniquely identifies a token and indicates whether the token is PIN protected. Thus the header content is:
header: <type><tin><pin flag>
   Type: Identifies the type of VBT (5 digits)
   Tin: Unique VBT Identifier (16 digits)
   Pin flag: Flag indicating pin requirement (1 digit

The header may not be encrypted. This is important in an open system in which the token type must first be read before a decision can be made as to what token type it is and, therefore, how it should be processed. The header, therefore contains information about the token itself. However, it is possible to provide a system embodying the invention in which the header is encrypted.

The payload will vary depending on the nature of the token and its application. It contains information, which is related to the use to which the token is to be put. In order to reduce the data content, and thus to enable the VBT to be encoded in a relatively small data carrier such as a data matrix, the actual data need not be stored in the payload. Instead an identifier is stored which, when read, enables data associated with that identifier to be retrieved from a database. Thus, for example, the database at the core/wrapper or elsewhere may store the bank account number, cheque number and sort code number of a cheque, together forming a bank identity. The payload merely holds data, such as an address that is sufficient to retrieve this bank identity from the database. The payload may be encrypted but it will be appreciated that the system is inherently secure as the information stored in the payload is meaningless, even when decrypted, without access to the database.

The content of the payload is specific to a wrapper and may even be omitted in some applications. The payload may comprise a plurality of data sets. In the description of the core above, these may comprise one or more datasets that are an additional payload and may be a reference to data or relational structures that are stored elsewhere, for example in the core repository. Each data set may be intended for a different purpose, for example for a different party or service. Thus, the content part of the Value Based Token comprises a header data set which contains data about the token itself which may be unencrypted and may be divided into a number of sub-data sets; and a payload data set which may be encrypted and which contains a reference to data relating to the subject of the token enabling that data to be retrieved.

If the token's security policy specifies that the payload is encrypted the cipher (encrypted text) will be stored in the payload. Due to the binary nature of encrypted data it will be base encoded before storing it in the VBT. One suitable encryption algorithm is the AES symmetric algorithm for encryption of payload content. Thus:
Payload content: <free text>|<cipher text>

The security mechanism 32 will vary according to the intended use of the token and the type of data carrier on which is encoded. The security mechanism is a cryptographic fingerprint and protects the payload and header from tampering and counterfeiting. For example, the security mechanism may comprise a SHA 256 Hash or an RSA Digital Signature. A Hash has the advantage of being small in size and can be generated quickly, whereas a digital signature is larger and takes longer to generate and verify, but is inherently more secure and non-repudiable. The appropriate security mechanism will depend on the use to which the token is being put and the degree of security required. For example, a token which represents a small discount on an item form a supermarket will require much lower security than a token that represents personal cash or a cheque.

Thus, the content and size of this section is determined by the security profile defined for the token type and the key strength used in security algorithms.

Security content: [<message digest>|<signature>]

Message Digest If the security policy specifies a hashing algorithm, the message digest is produced by the hashing the <header> and <payload>.

Signature: Where a signature is specified in the security policy the <header> and <payload> sections will be hashed and the resulting message digest signed with the service's private key to generate a digital signature. Due to the binary nature of message digests and digital signatures values will be base encoded before storing in the VBT.

It follows from the foregoing discussion of the core and the wrapper that the core defines the structure of the VBT and that the core also preferably defines the header and the security portions. The wrapper for that application may define the payload contents, which are specific to each application. Thus the syntax and semantics of the header and security portions are defined in the core as well as the supported encryption algorithms for the customer payload. The complete VBT is stored in the core but the payload is defined and constructed in the wrapper. If the payload contains references to other data or relational structures, for example due to capacity constraints of the data carrier, these too will be defined in the wrapper.

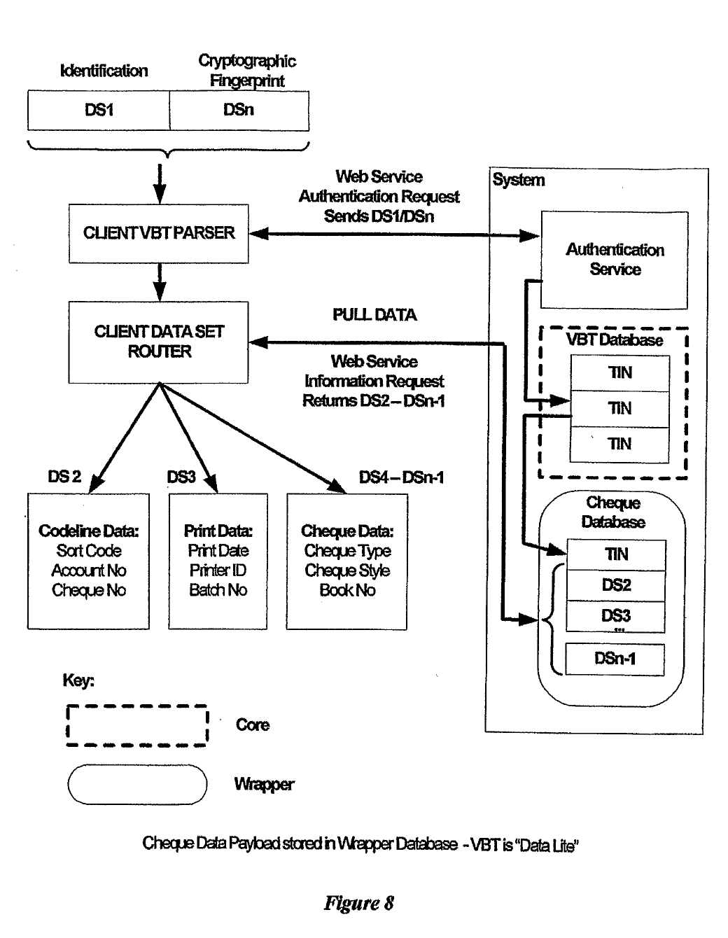

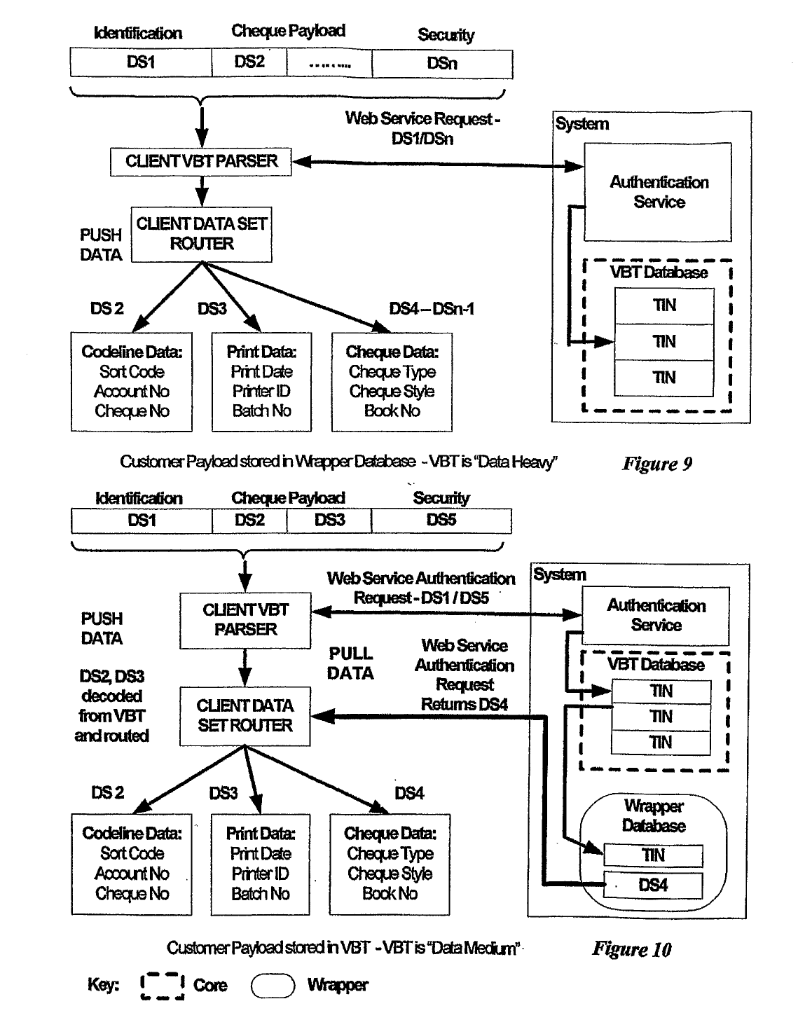

FIGS. 8 and 9 show how different VBTs can be constructed, depending on the application and the data capacity of the data carrier. FIG. 8 shows a data heavy VBT and FIG. 9 a data light VBT. In FIG. 8, the payload contains 1 or more data sets which, when read, are routed through a local data set router 100 which communicates with the system server 102 to authenticate the token TIN and routes the payload data sets to different end points. In the example of FIG. 9, there are three data sets in the payload: DS2, DS3 and DS4. DS2 is routed to a local authentication points such as a till, DS3 is routed to a marketing department and DS4 is routed to some other end point. An individual data set may be routed to more than one point, and the data in the data sets may have a degree of overlap.

In the FIG. 9 case, the VBT is data lite and comprises a header and a security section only. The payload is stored at the core server and referenced by the TIN in the header. In an alternative, not shown, the payload could include a data set that is a reference to data or relational structures stored elsewhere.

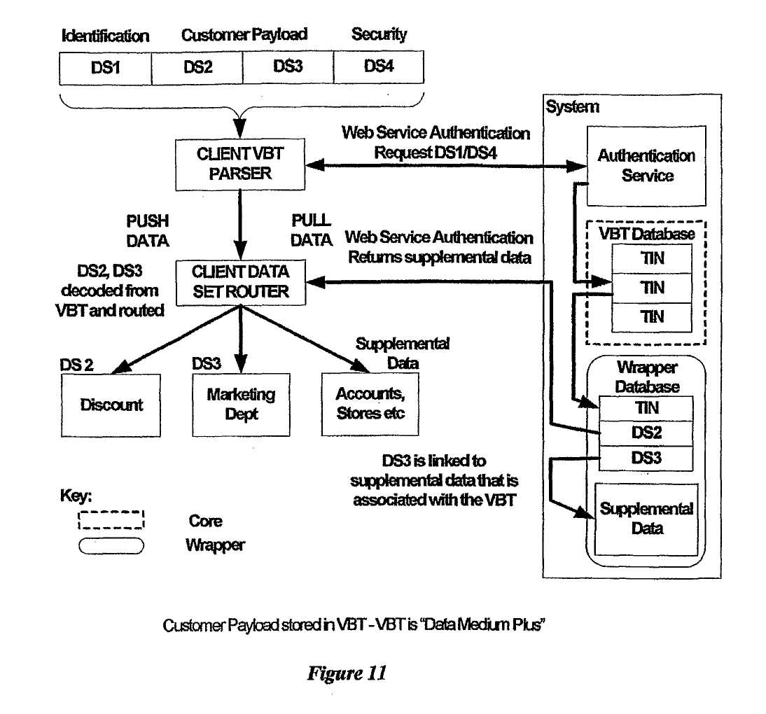

FIGS. 10 and 11 show intermediated cases where the payload carries some actual data but also references data stored elsewhere. In FIG. 10, the payload includes data sets 2 and 3. A fourth data set is stored at the wrapper database are is pulled when the TIN is provided for authentication. In the FIG. 11 example, one or more of the data sets in the payload is linked to supplemental data, shown as stored at the wrapper database. Thus, the TIN references the data sets and the supplemental data. This again reduces the amount of data that needs to be carried in the VBT.

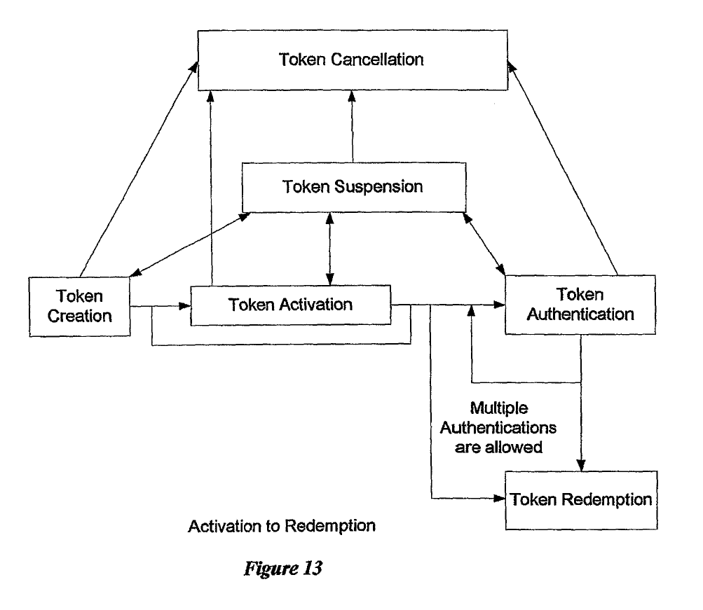

FIG. 13 shows the lifecycle of a VBT. A token may exist in a number of states: Created, suspended or redeemed. A change in status may occur through the activities of activation, cancellation or authentication.

The content of the VBT depends not only on the intended use of the token, but also on the nature of the data carrier that is going to be used to carry the VBT. Many types of data carrier are available. The data carrier is a portable data transport medium and, must be capable of storing identity data string components. A data carrier is usually a type of barcode or RFID device.

The data transport is constructed to have the generic format of the VBT:

| | | |
|---|---|---|
| Header | Payload | Security |

By using a common VBT for all applications, the common format and approach can be adopted even though different markets and applications have different requirements on how to place ‘identity’ data (or portable credential) onto an item and what that data item must include. For example, the level of security used may vary from minimal to very high. This has an implication on the amount of data that must be held in the data carrier and, in turn, what data carrier is appropriate. At one extreme, the VBT may have just a header and a security portion having low security. At another extreme, the VBT may include high security and a payload having several data sets each including a large amount of data. In between these extremes, the payload may have one or more data sets one or more of which may comprise a reference to data stored elsewhere.

Existing 1D barcodes (for example EAN 13 and EAN128) and 2D symbologies may be used. Examples are QR code and Maxi code, and the Data Matrix (DMx). PDF 417 barcodes, RSS (Reduced space symbology) codes and RSS Composite (1D plus 2D) may also be suitable.

Embodiments of the invention may be used in environments in which a chosen Data Carrier is already used, whether it is a printed or marked barcode or a RFID type carrier. This pre-existing barcode type may be required for the solution and may already have printing devices and scanning technology with which the system embodting the invention must work. In some cases, the VBT may be added to existing data carriers, such as a carrier used by a customer for other purposes. This is particularly possible on RFID devices which have a relatively large storage capacity but may also be possible on other carriers.

It is possible to create hybrid data from the actions and status of a client or consumer, for example by updating information and/or the data sets to create a new VBT either on the existing or a new data carrier. How the new hybrid VBT is sent to the data carrier depends on the wrapper but follows the same route for its predecessor and may occur at a different place. In a particular solution user rules may require the first carrier to be scanned again before the second is scanned providing a two part verification process building a authentication picture. This is desirable, for example, in a ticketing situation. For a coupon the new VBT may be an update of where a customer had used the coupon and what status had changed, ready for the coupon to be used again. In this context a receipt printed at a till could easily print out a new carrier.

Table 1 below shows a number of examples of data carriers that may be suitable for use with embodiments of the present invention, depending on the requirements of the application.

TABLE 1

1D Barcode type
(traditional range) eg EAN
13 or 128
Data Matrix (ISO/IEC
standard 16022)
QR Code (ISO standard
18004)
PDF 417 (ISO standard
15438 - June 2001)
Maxi Code -
Vericode
RFID - all types
(including Gen 2) also
known as Radio Barcodes)
CHIP -

Thus, the VBT is first created and holds the final identity output created in the system core before it is encoded onto the data carrier of choice. The VBT has header, payload and security components as specified in the wrapper that is specific to that application. Encoding the data onto a Data Carrier will not alter the information of the original VBT data string. Therefore in the example of the DMx it would turn the VBT into a DMx image which when scanned would translate back into the original VBT content. In an example of RFID the VBT would be onto the RFID tag.

It is preferred to optimise all data to suit the data carrier type. This may involve using specific character sets or base encoding to reduce unnecessary content overhead such as encountered when creating a DMx. Some data carriers have specific input formats.

In some applications, the data carrier will be held by a third party. An example is a manufacturing company who have their own data carrier (DC) generating software. A DC output can be an image or more common to a font generator so is treated like text. The font must be installed on the processing machine to see or print the image. The VBT may be sent out raw from the system for encoding by the customer.

When the system described serves a Data Carrier output, for example a DMx, it needs to suit the client's requirements. If a client has different delivery channels mobile, print via web, print to print company, print to marking technology etc. then the solution must be able to serve the optimal output for that channel. This is relevant to all 1 D barcode and 2D symbologies where, if an output is to an image format rather than a “font”, the physical size, dpi or pixel size has to be considered and matched to the requirement. In an example where a consumer could choose from a range of options to collect his coupon such as phone, home print etc, kiosk the system is able to create specific graphic outputs.

In one embodiment of the invention, more than one type of carrier output may be provided. For example, an RFID tag may be used with a traditional printed barcode. In that case, the system may supply two identities: the DMx and RFID information. These identities may be the same but allow for different scanning routes. In one embodiment of the invention, where a single DMx, or other chosen data carrier, is not able to contain all the data or where 2 identities need to be issued to a single item (containing different information or for different uses), then two or more data carriers may be issued.

FIGS. 8 to 11 also show how a data carrier with an encoded VBT may be read. The data carrier is first scanned to recover the VBT. The header in the VBT is not encrypted and from this the scanner, shown as the VBT Parser, can determine the nature of the VBT. For example, it may identify the VBT as a coupon, a cheque, a ticket etc. This may affect the way in which the recovered VBT is processed. In FIG. 8 the VBT is constructed as data lite, which means that there is no payload. The TIN in the header is used to authenticate the wrapper and is used to access data sets that are stored elsewhere. In FIG. 9, the VBT is data heavy and the datasets are in the VBT payload. Thus, in FIG. 8, the VBT is recovered by the VBT parser, which sends an authentication request including the header and cryptographic fingerprint data sets to the authentication service. The TIN is recovered and compared with the TINs stored in the core repository, and if there is a match and authentication confirmation is sent to the parser as described above. In addition, data that is associated with the TIN, which is shown stored in a wrapper repository, but which could be elsewhere. This data comprises one or more data sets and may comprise data that is in the payload in the data heavy example. These data sets are pulled by a data set router and distributed to on of a number of recipients. As shown in FIG. 8, different recipients may receive different data sets although it is possible for each recipient to receive any or all of the data sets. In the FIG. 9 case, the data sets stored in the wrapper database in FIG. 8 are already part of the VBT and are pushed by the client data set router to their intended destinations.

The data-lite model for the VBT shown in FIG. 8 enables discretionary (DAC) and mandatory access controls (MAC) to be placed on the content referenced by the TIN in the core database. Discretionary access controls are generally granted by a person such as the object owner and determine read and write access privileges to the object to users and groups of users. Mandatory access controls are enforced by the operating system or database and protect classified data that has been protectively marked or labelled from being inappropriately accessed or disseminated to those with insufficient security clearance. This is a multi-level secure (MLS) implementation of core suitable for Government applications such as a National Identity card scheme.

For a VBT that represents the identity of a person in the form of a serial number, this scheme can be used to control the type of information that is returned about that person. In order to implement this level of control the core database needs to know who is making the request; what role the person is fulfilling; and the location from where the request is being made. This identity based information can be obtained from an X509 certificate identifying the client making the information request. The client is a trusted node in the network with a pre-defined security clearance.

The manner in which a data carrier may be presented to a user may vary according to the application. For example, where the VBT represents a coupon for redemption in a supermarket or other store, the user will access the website of the supermarket or a particular supplier or manufacturer and be able to download the coupon. This will involve a VBT being generated and encoded onto the data carrier as described above. The user can then print the coupon including the data carrier a present it for redemption at the supermarket checkout. Alternatively, the coupon need never be printed but may remain in electronic form for redemption against electronic purchases.

Thus embodiments of the invention use a value based token which is encoded onto a data carrier. The VBT comprises a clear header, a payload, which may be encrypted, and a security section. The header is a data set which allows the VBT to be identified and may comprise a number of sub-data sets. The payload is a further data set, which contains information, which allows a reader access to data. The payload could be split provided that the reader is able to distinguish between two different data sets. As the payload does not contain actual information about the token, but a pointer to where that information is stored, the security of the token is improved. Moreover, the token is far more flexible that prior art examples which are limited by the ability of the data carrier, such as a data matrix or bar code to carry information. As the information about the token is not actually held in the payload, this problem is avoided.

The VBTs are generated, stored, authenticated and redeemed by a system, which comprises the core and one or more application specific wrappers. This approach provides a system which can generate tokens for a wide range of applications with all common operations being performed by the core and application specific operations performed by the application wrapper. Thus, different data carriers may be used, or different payload structures used without affecting core operations. This is highly advantageous.

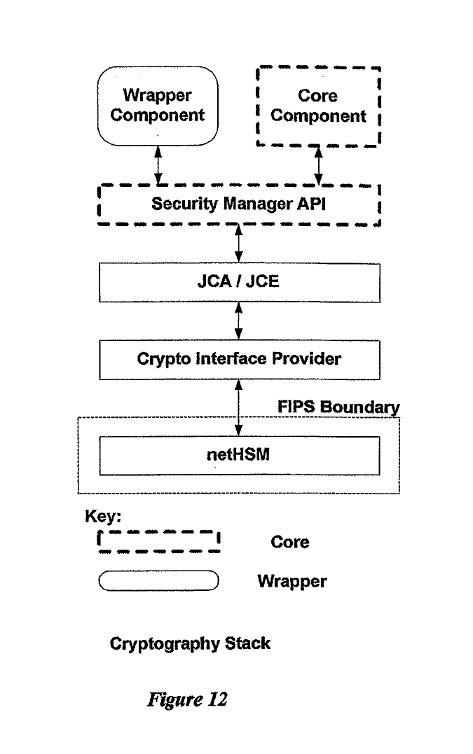

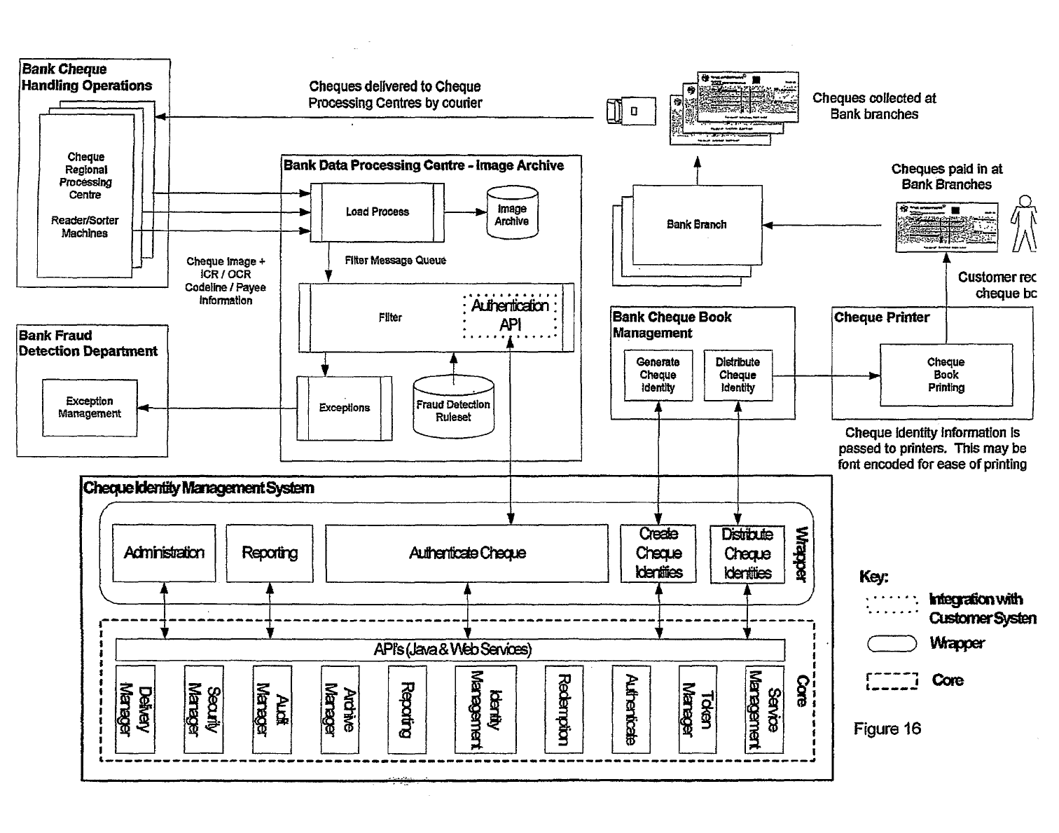

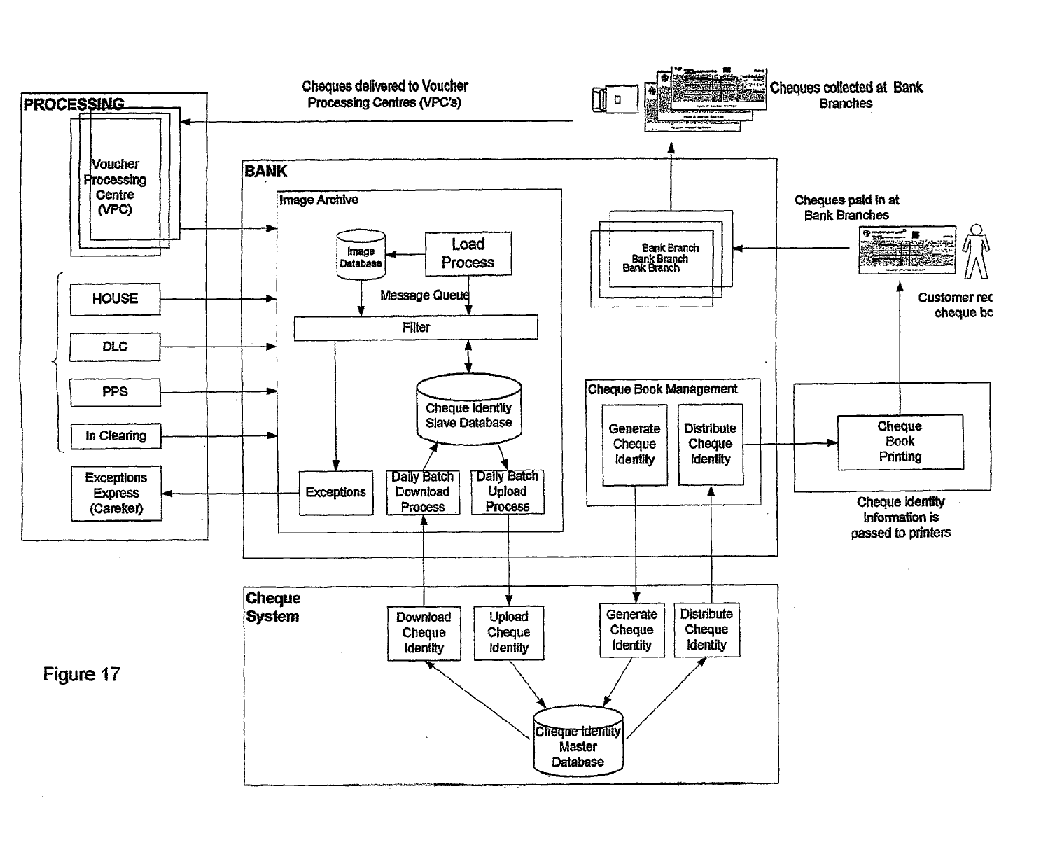

FIG. 12 shows how cryptographic functions are handled. All cryptographic functionality may be implemented using the Java Cryptography Architecture (JCA) and Java Cryptography Extensions (JCE) APIs. The cryptographic functionality within the core may use nCipher's netHSM Hardware Security Module (HSM). The netHSM is a FIPS 140-2 Level 3 validated security boundary, i.e. a proven certified security boundary meeting cryptographic best practice. As shown in FIG. 16, the HSM is accessed using nCipher's JCE provider implementation (nCipherKM JCA/JCE CSP) to perform encryption, decryption, key generation etc. Other JCA/JCE providers could be used.

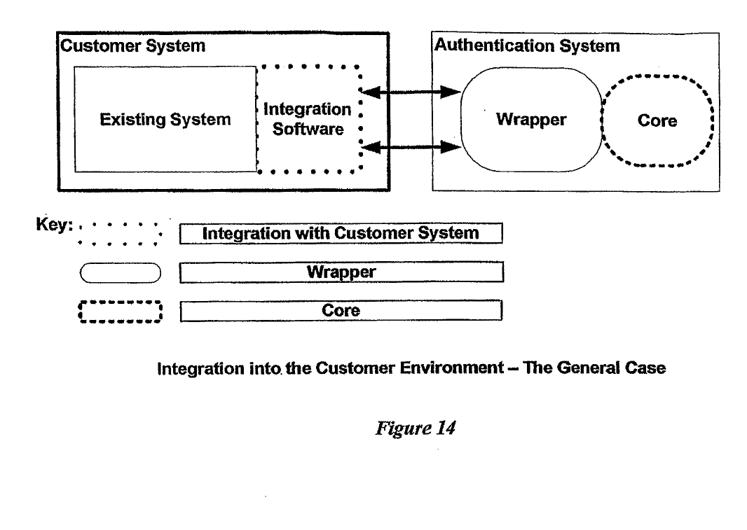

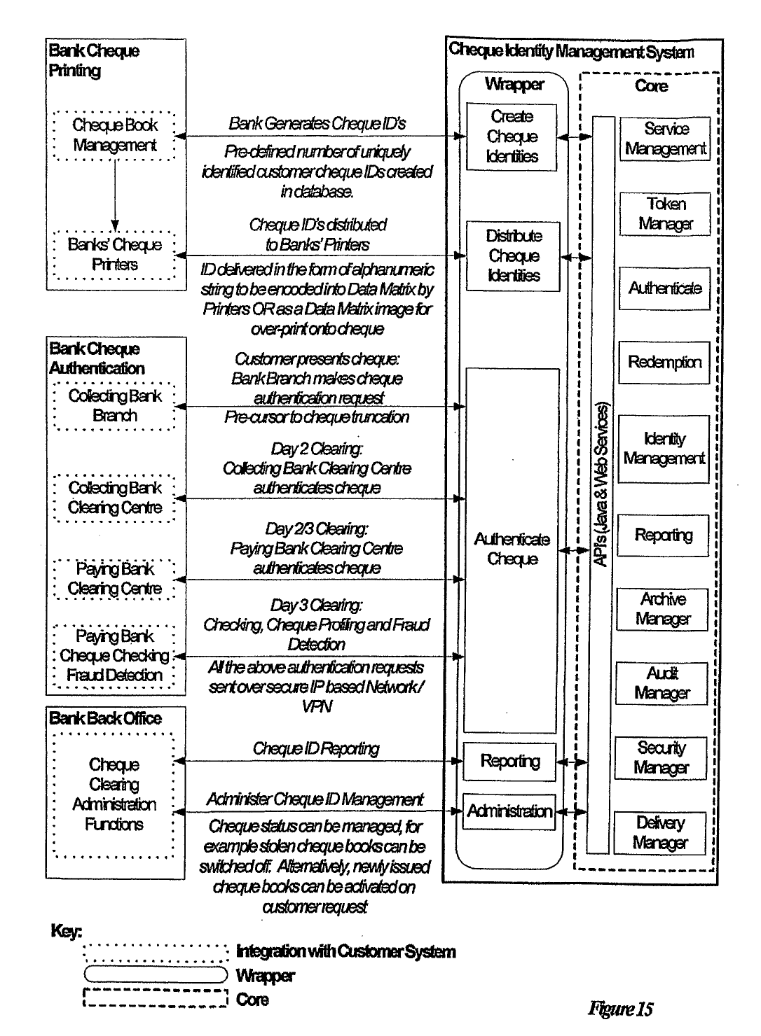

FIGS. 14 to 17 show examples of how the core and wrapper may be configured in a specific example of a cheque clearance process in which the VBT encoded on a data carrier is placed on a bank cheque. The system embodying the present invention comprises the core and the application wrapper shown in FIG. 13. This must integrate with a customer's existing systems by means of integration software. The various functions of the integrations software, the wrapper and the core are shown in FIG. 15. The functions of the core were described above and will not be described further. The wrapper creates individual cheque identities on the basis of information provided from the bank computer systems. These are not the same as TINs. A TIN is a number, which is incorporated into a VBT and is used to identify uniquely that VBT, which in this instance represents an individual cheque. The VBT is a secure and unique identity that incorporates or references parameters of the cheque. The wrapper passes the identity information to the core and also acts as an intermediary between the bank system and the core for the distribution of cheque identities, authentication, reporting and administration. Thus the cheque identities created by the core are passed to the bank system to be encoded onto a data carrier and placed on the printed cheque. The authentication process involves the bank communicating with the core via the wrapper, typically by a secure IP based network or virtual private network. When the customer presents a cheque, the bank branch will make an authentication request. In the clearing process, the collecting bank clearing centre may authenticate the cheque and then the paying bank will authenticate the cheque. After both sides have authenticated, further checking, fraud detection and cheque profiling may be used to complete the clearing process. In addition, the bank back office systems may communicate with the core via reporting and administration modules in the wrapper for administrative and reporting purposes. In a preferred embodiment, authentication is performed only by the bank by whom the cheque identity was created as they are the only party who has access to the system.

In the embodiments of FIGS. 14 to 17, the core and wrapper as described above may be embedded in existing bank systems rather than being a separate web service based system. The system is preferably used to authenticate the cheque as genuine, rather than to encode details of the payee and the amount of the cheque. Existing cheques are normally created using bank specific design pre-printed folio stock which is generic until it is personalised at the bank's secure print facility. The personalised information such as the name, date of issue, cheque number and the sort code of the bank is then added to make it account holder specific. These are usually printed using a combination of laser type ink and MICR (Magnetic Image Character Recognition) ink. In this embodiment of the invention, a further data carrier, such a graphical symbol, for example a data matrix, or an RFID tag is added to the cheque. In the following discussion, a data matrix will always be referred to although it will be understood that any other data carrier including RFID may be used.

The data encoded by the data matrix provides a secure identity for cheques and their account holder to whom it is issued. These identities are sent, together with conventional customer cheque personalisation data to the cheque printers to enable them to print cheques using pre-printed cheque folios. The data matrix is applied to each cheque and contains, encoded therein, a VBT generated as described above. The VBT may contain the cheque related data or may reference a location at a remote database where that information is held. This latter approach, which is presently preferred for reasons discussed below, uses the data lite VBT discussed above with reference to FIG. 8. In selecting this approach, a balance is struck between the amount of data that has to be stored in the data matrix, the size of data matrix that can be printed on a cheque, and the resolution of that matrix which is practical. In particular, it will be appreciated that space on a cheque for a data matrix is limited. Although a higher resolution matrix can contain more information than a lower resolution matrix, for a given size, it is important that the matrix can be read reliably and is robust enough not to be damaged easily and still be readable if it has been damaged, for example by folding or after spillage of a liquid on it.

In one embodiment, the data referenced by, or carried by the VBT contains the bank sort code, the customer account number, the cheque number and the print date. By using indirect coding to enable the TIN to reference the payload in the wrapper, the number of characters may be minimised. For example:

TABLE 2

| Data | Description | Size (in chars) |
|---|---|---|
| Type | VBT Type - Bank Cheque | 8 |
| TIN | 12-digit number | 12 |
| Flag | Y/N - default to N | 1 |
| Security | HMAC-SHA-1/HMAC-SHA-256 | 28/44 |
| Total Size | | 49/65 |

Table 2 shows how the character content to be encoded onto the data matrix may be reduced to 49 or 65 characters depending on the hash function that is chosen. The total size will depend on the type of coding used. The smaller the VBT content size, the larger the resolution of the data matrix that can be printed for a given matrix area.

In Table 1 above, the TIN is selected as a 12 character number. A UK bank has an estimated 720 million cheque identities created a year. On this basis, a 12 digit TIN can represent over 1300 years of unique cheque identities. The character length of the TIN is configurable. Thus, in the table 1 example, the data matrix carries the TIN, the VBT type, the Flag and the HMAC. The TIN provides a reference to the payload: sort code, account number, cheque serial number and print date, stored at a remote database, which may be the core database or elsewhere. FIG. 17 shows a VBT that is encoded according to FIG. 1. The data to be encoded in the data matrix is first produced as a character string that is sent for encoding as a font and optimised for the data carrier selected. In a preferred embodiment base 32 coding is used to convert the binary value for the HMAC into printable characters and the coded characters then turned into a font string.

Referring back to FIG. 15, it will be appreciated that cheque identities are initially created by the cheque wrapper on request from banks, for example as part of a bank's cheque book management system. The wrapper distributes the cheque IDs to the bank's secure cheque printer facility either as an alphanumeric string for encoding into a data matrix by the printers, or further encoded into a specific font compatible string based on the original VBT data string. Alternatively it can be already encoded as a data matrix image which can then be overprinted onto the cheque.

Once printed, the cheque is distributed to the customer for use. At this point, the status of each cheque can be set in the verification database. Once issued, the TINs representing the distributed cheques can be set as being active. The ID may be unique to each cheque or unique to a group of cheques, such as those making up a chequebook. This could be performed by the bank on distribution or on notification by the customer of safe receipt so that cheques that are intercepted in the post and then fraudulently used can be detected in the authentication process to be described. The customer will use the cheque for payment for goods or services. Authentication of the value of the cheque, its date or the payee are not provided by this embodiment of the invention. However, the authentication information provided by embodiments of the present invention may be used as part of a broader fraud detection and reduction system.

The following description is concerned with how the cheque is authenticated when it enters the clearing system. The examples shown in FIGS. 16 and 17, which are two alternatives are representative of the UK cheque clearing system. However, it is to be understood that these are examples only and that the embodiment of the invention is applicable to any cheque clearing system.

As part of the cheque clearing system in the UK cheque truncation is used. In the US a process known as ‘check 21’ is used. The words cheque and check are used interchangeably in this document, the former being the British English spelling and the latter being the US English spelling. Cheque truncation comprises scanning the cheque to make an image of it and storing the image rather than the original cheque. The image will be of both sides of the cheque. In the check 21 system, the scanned image becomes the legal version of the cheque. A problem with this approach is that existing cheque security mechanisms, such as those using magnetic inks, UV inks and other special inks used to create cheques and folios, are lost when the cheque is scanned. There are, therefore, no existing mechanisms to secure cheque from manipulation once it has been imaged. It should be noted that essentially visual security mechanisms such as digital watermarks are not well suited to low resolution imaging of the type used in cheque truncation systems as the resultant image produced by the scanning process is of too poor quality to be usable.

FIG. 16 shows an overview of the cheque generation and authentication process. The chequebook management system 300 interacts with the wrapper to request generation of cheque identities by the wrapper at 310 and passes those generated identities to the chequebook printers 330 at 320. The wrapper generates the new identities at 340, passing them to the cheque identity database. The wrapper then passes the cheque identities from the database to the chequebook management system at 360.

From the printing stage 330, cheques are distributed to customers 360 who receive cheques and use them to pay for goods of services. Used cheques are paid in by the payees at local bank branches 370 from where they are collected at 380 and sent to a cheque operations handling centre. From the cheque operations handling centre, the cheques are imaged by scanning on both sides, and sent to the bank's image archive 400 where they are stored in an image database 410. The scanning process includes reading using MICR and other photo ICR (Intelligent Character Recognition) and OCR (Optical Character Recognition). Different parts of the image obtained are used for different antifraud and anti counterfeiting measures such as checking the customer's signature against a sample of the signature stored in a database. At this point, filter 420 performs various checks on the cheques and any exceptions, which appear not to be correct are spotted and sent to the bank's fraud detection department 430. Regardless of whether an exception is detected, the data matrix is scanned to retrieve the encoded VBT to retrieve the TIN, which is authenticated against the TIN record stored in the database. Exceptions detected as a result of the scanning of the data matrix are also sent to the bank's fraud detection department.

It is important that the size of data matrix chosen is compatible with the image archive. It is common practice in the archiving of cheques to use low resolution scanning, producing images around 200 dpi, to reduce file sizes and to enable other fraud detection system to work. Thus, the size and resolution of the data matrix are important. As the available space on a cheque is limited, the best approach is to minimise the amount of data stored on the data matrix. Thus, the payload is not stored on the matrix but is referenced by the 12 character TIN on the matrix.

The authentication process starts with verification that the cheque identity is authentic (unique and is recognised by the system). Linked to this is a status of the cheques identity—e.g.: released, withdrawn, stolen, active (not yet redeemed), or already redeemed. It will also report when identities are not recognised which might be for of a number of reasons not all crime or fraud related: for example accidental damage to the cheque making the data matrix unreadable. Other examples include deliberate defacement where someone has purposely defaced the data matrix to try and alter the identity of the matrix or to stop it being read. A further example may be the use of look-alike data matrices whether they are unreadable or not. Even though a matrix may be readable it may not be capable of being authenticated. The Authentication system will recognise where a matrix has already been authenticated and redeemed and report/flag that image authentication transaction.

An issue that arises in cheque security systems is that of false positives, where cheques are incorrectly flagged as fraudulent. In the case of the system described here, this means cases where an authentic cheque is not authenticated by the system. The use of a robust data matrix with minimum data content, the payload being stored elsewhere, reduces the likelihood of a correct data matrix not being authenticated.

It can be seen that when the cheque is scanned electronically, by say an imaging device, to capture and convert it into an electronic image to enter it into the image archive, so also the data matrix on the image is also captured in the scan even if it is not necessarily read or authenticated at this stage. Unlike basic security and processing measures such as magnetic ink on the MICR (Magnetic Image Character Recognition) line data, the imaging of the cheque does not affect the ability of the data matrix to be read to retrieve the contents of the VBT. The cheque images stored in the image database are analysed to identify a data matrix. If found, the data matrix is decoded to retrieve the character string that forms the VBT, and the string, or just the TIN, is passed back to the authentication database. If the data matrix is verified as genuine, the application also checks to see if the cheque has been presented before and/or to check its status against any other parameters set by the bank. Such a parameter may be specified on the wrapper or by some other parameter such as, for example, the credit status of the account holder or some other rules based process. This may involve linking into other existing anti-fraud and authentication systems.

It will be appreciated that any attempt to alter the data matrix will fail as error correction used in the specification and production of the data matrix will render the altered data matrix unreadable. If the alteration is within error correction limits the data encoded in the data matrix will remain unchanged. A data matrix produced by any other means and applied to a cheque could either not be read or would be meaningless and would not be authenticated since it has not been produced from the system.

The positioning of the data matrix will be a matter for the individual bank issuing the cheque together with requirements laid down by regulatory authorities such as APACS in the United Kingdom, and will be partly affected by other security measures carried by the cheque. However, it is preferably positioned to avoid accidental damage or defacement.

The embodiment described may be used principally as an anti fraud/anti counterfeiting solution which is seen as an addition to existing security measures such as: microprint, UV, special paper etc. It gives a secure digital identity that can be easily linked to networked Authentication systems in a number of ways. It is particularly suited to use with the Image Archive which banks use as part of the clearing process and can be used as part of check 21, the USA cheque truncation route, which allows an image to replace the original paper document. Using the data matrix allows the bank/s to create and control another element of identity that they do not currently have.

The embodiment described may also help prevent fraudulent copying of cheques where multiple cheques are created and identities are swapped or reproduced. It also helps to avoid chequebooks stolen in the post being fraudulently used and being processed in the clearing system.

In the embodiment described above, the authentication of the data matrix is performed as part of the image archive process. However, authentication can take place at other stages of the process between creation of the cheque with a data matrix and the clearing of the cheque. As described, the authentication system is integrated into bank systems, but, as mentioned above, may be separate and cooperate using web services.

Thus the data matrix could be read at a number of different points, including:
1) At presentation to High Street bank where it may be scanned using a traditional hand scanner or equivalent. The scanning reads the matrix and can then access an online authentication path;
2) At back office of larger bank in cheque sorter. The scanning reads the matrix and can then access an online authentication path. At this stage the office may also send the scanned image to the bank's image archive for later use or reading;
3) By the cheque receiver, for example a retailer, to check authentication;
4) As part of the Cheque clearing process. A Cheque sorting machine which sorts cheques, reads the MICR line and images the cheque. From here OCR and ICR processing takes place and the data gathered from the cheque is then fed to the Banks' other systems for onward processing. The scanned image may be sent to the images archive and is then scanned with software that can interrogate each image and find a Data Matrix that can be decoded so that its data can be authenticated as described above.

The data matrix could be read at any point provided there is a scanner that can either read, for example using in-head decoding, the data matrix in real-time or has a software application that can decode the resultant image, provided it contains a data matrix, then the Authentication process can be scheduled to happen in real time or later.

The system may work in real time, at the first scan, when the cheque is scanned but before or as it becomes an image. Alternatively, it may occur later once it is in the image archive.

In the printing procedure described above, the bank chequebook management system sends single or batch data to a secure print house. This includes the chequebook printing company, which confirms an individual cheque has been printed. That cheque can be turned on and off for example if a customer reports a stolen chequebook. At the printing stage, the data matrix may be read to provide a check that a matrix applied to a cheque is readable and authentic. The matrix may be checked against the data that was sent to the printing house.

As mentioned above, the presence of a security mark on a physical cheque does not guarantee that the scanned image has not been tampered with in some way. In one embodiment of the invention, the imaged file may be sealed with an additional symbol such as a data matrix. Thus, twin marks are used: one to authenticate the original cheque identity and one to secure the image to stop either being altered.

Under the Check 21 truncation process, the image as a constituent part of the Substitute Check or IRD (Image Replacement Document) becomes the primary legal document replacing the original paper cheque. There is a danger in that the image electronic format such as a jpeg or Tiff (compressed or otherwise) is not in itself secure. The image can be manipulated and the detail changed. In the case of a cheque the payee or payment amount could be altered. This could mean the wrong cheque details being used for any remaining transactions involving the cheque. In the event of a dispute it would be difficult to prove the cheque had not been altered.

By using a similar solution to that described above it is possible to “seal” the image.

It is important to recognise the difference between the image in its digital form and the image when it is printed out. Solutions where the image file has encryption are entirely logical and are known in the art but as soon as the image is printed there is no “digital authentication” or encryption and, as described above, degradation of the image would render digital watermarking inoperable. The scanning of images may take place at the bank that is the first point of presentation or at a federal level. Smaller banks, who can't process images, tend to receive the check 21 images and then print them out because they are unable to handle the check process in any other way. This leads to the possibility that fraud can take place at this stage or whilst the image is being routed. Larger banks may also print out the images as they may, on customer request, return the cancelled check to the account holder.

By having a secondary symbol, data matrix or otherwise, encoded as part of the overall image, assuming there is a data matrix on the original cheque too, it is possible to create an authentication pathway that leads back to the original creation of the image and any record attached to that. The second data matrix is placed in the image file next to or within the boundaries of the main image as part of the cheque imaging process. A suitable place is region 8F on the IRD or substitute cheque which is reserved for a security feature as mentioned in standard ANS X9.100-140-2004. In the case where the scanning point at which authentication takes place has a link to the first authentication pathway a hybrid data matrix can be created which references the original data and its new hybrid data matrix. Since the content of the data matrix is hidden it is impossible for its identity to be changed with any certainty of what to put in its place. As most cheque sorting and clearing machines are capable of reading the payment amount at the same time, the hybrid data matrix may have encoded into it, or referenced, the payee details and the amount. Scanning of the image when it is printed out, or read from an image archive allows authentication of the results and the cheque's status. The second symbol may be printed on the cheque before imaging takes place or it may be added to the electronic file produced by imaging the cheque including the first data matrix. The hybrid data matrix provides greatest security when it carries data that has been provided from the databases by authenticating the first data matrix. However, use of an unrelated second data matrix can still enhance security.

It will be appreciated that the encoded token, or glyph, effectively replaces the cheque once imaged. This is the case whether or not there is a secondary glyph or a hybrid glyph produced. It is immaterial whether the glyph is first printed onto a cheque and then imaged, or whether it is created in electronic form and then applied to the existing electronic image of the cheque.

In table I above, the VBT is described as optionally including a flag. The Flag (Y or N) indicates at the point of scanning whether some form of input is required as part of a staged authentication process. The flag may be linked to a PIN (Personal Identification Number) and at the point of presentation, for example a Bank Counter or a retail point of sale checkout, the Account Holder is asked to enter the PIN into an authentication device such is used for “chip and PIN” authentication. In this embodiment the VBT does not hold the PIN, which, for security reasons it is held on the Authentication database as one of the datasets.

The process may be implemented as follows: The Account holder presents his cheque—made out to Cash or as a payment routed through the bank to a payee account. The cheque is scanned to read the cheque security Glyph and the resultant VBT data string is sent using secure web services over a secure IP based network, for example a VPN, to the authentication database. In one preferred embodiment, where the solution is not closed loop, the VBT contains a ‘Type’ identifier which ensures it is directed to the appropriate bank's Authentication Network.

The authentication network can verify the authenticity of the individual cheque by comparing the VBT to the entry on the database—this tells the Bank teller that the cheque is authentic and has not been used yet, and/or reports on the cheque's status such as having been withdrawn or stolen. The PIN authentication verifies that the person presenting the cheque is the holder of the PIN information and is therefore is the owner of that cheque and entitled to proceed with the transaction. In this embodiment it is not intended to verify the status of any of the other details on the cheque such as account balance. Thus it provides a simple a method for combating fraudulent use of other people's cheques by verifying both ownership of the cheque and that the cheque itself is likely to be genuine.

In one embodiment the point of presentation is a retail store.

Other known solutions such as digital watermarks used to combat this type of fraud rely on special software being present on the scanning machine to enable offline decoding of embedded data held on the actual digital watermark. The method described above requires a handheld scanner or the like which is common at all points of presentation and is part of the existing infrastructure, especially in the retail environment. By using a data carrier such as a data matrix that is an ISO standard, proprietary equipment for the solution is not required.

In one embodiment the location and the identity of the point of presentation would be passed to the authentication database during the authentication and stored.

As stated earlier in this embodiment, the authentication of the cheque and the person using it as a method of payment, is suited to banking and retail environment as they already have the required infrastructure.

In one embodiment, when the cheque is presented to an individual rather than a business, they can remotely connect to the authentication database via the internet using a Personal Computer with a scanner or a mobile phone. Mobile, or cellular

phones are available that can scan barcodes such as the data matrix. Connection to the internet via mobile telephony is well known.

The system described above allows other functionality as part of the PIN protection of a cheque. The PIN on the authentication database can be issued by the account holder's Bank much is as done at present with credit cards. The PIN may be the same for every individual cheque issued in that book. However in one preferred embodiment the account holder is provided with an online link via an internet banking interface to an area where he can select a PIN of choice. Because every cheque contains a unique VBT identity, every cheque could have a unique PIN. This is possible because the PIN identity is not stored on the VBT but on the authentication database. The flag, in the VBT can be set by the bank or the account holder to be on or off but this must be done prior to the generation of the VBT and its printing on the cheque.

Using the account holder's online banking interface described above, the PIN number can be set in advance and if required changed at any time later prior to using the cheque. This facility can be used to change a PIN of a cheque or a group of cheques if somehow the PIN number has been disclosed or lost. It is presently preferred that a single PIN would be applied to each chequebook.

This embodiment does not address the situation where the cheque is presented by anyone other than cheque account holder where the account holder is not present to enter the PIN, for example where a cheque is posted to a payee. In this situation, the account holder may select a unique PIN for an individual cheque and may pass on that PIN to the payee so that when he presents it at a bank the Authentication process can verify the presenter is a valid party to that transaction. This is only a valid approach where trusted parties were involved. This approach allows the account holder not only to pass the PIN as part of the transaction but also for the value and the payee to be entered into the authentication database as part of the authentication process. This approach is also suitable for banking cheques such as a banker's draft.

The embodiments described may be used as, or integrated into, existing positive pay systems already used in some banks to authenticate cheques. Positive pay is a known system in which an entity issuing cheques sends details of cheques issued each day to their bank. When those issued checks are presented for payment at the bank, they are compared electronically against the details provided by the cheque issuer. Typically, the check-issue file sent to the bank contains the check number, account number, issue date, and amount. Usually the payee and signatory details are not included.

When a check is presented that does not have a match in the file, an exception is raised. Once an exception is raised the Bank will follow a variety of actions depending on its rules and policy for example the bank notifies the client, for example by sending an image of the exception item. The client reviews the image and instructs the bank to pay or return the check.

Positive pay is an effective way of combating fraud but is not foolproof. Typically, positive pay systems identify high value cheques which may lead to them being checked further manually. This may involve comparing the signature on the cheque with specimen signatures. This is a process that is difficult to automate as any medium sized company will have a large number of people who can sign cheques on behalf of the company and so a large number of signatures must be compared. Indeed the resources including processing resources required by an automated signature checking system can be greater than required by the rest of the positive pay system. Usually, in the UK banking system, cheques clear over a three-day period. The positive pay system generally works during the second of those three days which gives limited time to check errors revealed by the checking system. By integrating the imaging of the data carrier holding the VBT into the positive pay process, the procedure can be speeded up, enabling checking to be completed by the end of the first day, thus giving parties issuing cheques much more time to deal with exceptions.

Exceptions may be genuine errors or fraudulent. Whilst providing improved security, positive pay is still vulnerable as it does not usually check payee details. Thus, it will not work if the wrong details are entered due to error or deliberate fraud. The VBT may include, or reference payee data to improve the security of positive pay or may simply contain or reference existing positive pay data to provide the increased processing speed mentioned above.

The system may be used to provide automated signature checking without the heavy processing overhead mentioned above. This can be achieved through use of the PIN flag discussed previously. For example, an authorised signatory may enter a PIN when the cheque is created. That PIN is part of the data sent to the bank. The bank has stored against each authorised individual their specimen signature and their PIN. Thus, to check the signature, once the PIN is retrieved, only a single signature has to be compared. This vastly reduces the processing required and makes automated checking of signatures viable. This feature may only be activated for high value cheques, above a bank or user defined threshold, but could be used for all cheques. As an alternative, this benefit could be achieved by encoding the identity of the signatory into the VBT so that only one specimen signature need be compared. By encoding an identifier into the token, the absence of any identifier at the point of checking would cause an exception to be raised, even if a manual check of the signature indicated it was genuine.

An alternative use of PINs is to prevent access to the cheque details encoded in the VBT so that the VBT can only be unlocked by an authorised party who holds the PIN. Again, this is a feature that could be used for high value cheques.

Thus, the PIN may be used to enable a cheque to be unlocked and/or to provide for verification of the signature that may then be automated.

Within the positive pay environment, the process of generating and applying the encoded carrier or glyph may be different to the various embodiments described above. A bank may only issue a positive pay glyph when information about the cheque is received from the issuer. The glyph, and the token it includes, is a transaction sealing device and is applied to the cheque by the issuer, who is typically a medium or large organisation which prints its own cheques on receipt from the bank. As an alternative, the bank may provide clients with advance batches of tokens which it can then assign but this is presently perceived as not as secure as the previous example.

The embodiments of FIGS. 14 to 17 have been described with respect to cheques, but may also be applied to other financial instruments and security papers such as, but not limited to, paper money, shares, travellers' cheques, and vouchers.

1. A cheque authentication system comprising:
a cheque identity generator for generating cheque identities,
a store for storing cheque identities;
a token generator for generating a token having a header and a security section, the header including a first data set including an identifier;
a token converter for converting the token into a character string;
an encoder for encoding the character string onto a data carrier,
means for applying the data carrier to a cheque;
an imager for imaging completed cheques each including a data carrier;
means for reading an image of the data carrier in an image of a completed cheque to read the character string from the data carrier; and
means for authenticating the cheque by authenticating a cheque identity derived from the character string against the stored identity.

2-4. (canceled)

5. A system according to claim 1 wherein the header of the token includes a PIN flag indicating whether a PIN is required to validate the token.

6. (canceled)

7. A system according to claim 1, comprising means for applying a further data carrier having an identifier encoded thereon to the image of the cheque formed by the imager.

8. A system according to claim 1, comprising means for applying a further data carrier having an identifier encoded thereon to the cheque and for forming an image of the cheque including the further data carrier.

9. A system according to claim 7, wherein the further data carrier identifier is related to the identifier encoded on the first data carrier.

10. A system according to claim 1, comprising means for generating a further data carrier after imaging of the said data carrier, the further data carrier having data encoded thereon related to the data encoded on the first data carrier, and means for either applying the further data carrier to the image of the cheque formed by the imager, or applying the further data courier to the cheque and forming an image of the cheque and the further data carrier.

11-16. (canceled)

17. A method of authenticating cheques, security papers and the like, comprising:
generating a unique identifier for the cheque;
storing the unique identifier;
generating a token having a header, and a security section, the header including a first data set including the identifier;
converting the token into a character string;
encoding the character string onto a data carrier;
applying the encoded data character to a cheque;
imaging completed cheques including imaging the data carrier;
reading the image of the data carrier contained in an image of the completed cheque to retrieve the character string from the data carrier; and
authenticating the cheque by authenticating a cheque identity derived from the character string against the stored identity.

18-19. (canceled)

20. A method according to claim 17, wherein the token includes a PIN flag indicating whether a PIN is required to validate the token, and wherein the authentication of the cheque includes validation of the PIN.

21-22. (canceled)

23. A method according to claim 17, comprising:
generating a further data carrier after imaging of the said data carrier, the further data carrier having data encoded thereon related to the data encoded on the first data carrier; and either
applying the further data carrier to the image of the cheque formed by the imager or
applying the further data carrier to the cheque and forming an image of the cheque and the further data carrier.

24-25. (canceled)

26. A method according to claim 17, comprising:
applying a further data carrier having an identifier encoded thereon to the cheque; and
forming an image of the cheque including the further data carrier.

27. (canceled)

28. A method of securing the authenticity of a cheque, comprising printing the cheque with a first graphical symbol, the graphical symbol having encoded thereon a token including a unique identifier for the cheque,
imaging a completed cheque on remission of the cheque to a bank, thereby to form an electronic image of the cheque; and
securing the cheque with a further graphical symbol having an identifier.

29-30. (canceled)

31. A method according to claim 28, wherein the further graphical symbol contains information retrieved from a database by scanning the first graphical symbol to retrieve the unique identifier and retrieving the cheque related information stored at the database and referenced by that unique identifier.

32. A method according to claim 28, wherein the second graphical symbol is printed on the cheque and the electronic image of the cheque comprises the first and second graphical symbols, or is applied to the electronic image of the cheque after the cheque has been imaged.

33-34. (canceled)

35. A system for securing the authenticity of a cheque, comprising:
a printer for printing the cheque with a first glyph, the glyph having encoded thereon a token including a unique identifier for the cheque,
an imager for imaging a completed cheque on remission of the cheque to a bank, thereby to form an electronic image of the cheque; and
a cheque securing device for securing the cheque with a further glyph having an identifier.

36-38. (canceled)

39. A system according to claim 35, wherein the second glyph is printed on the cheque and the electronic image of the cheque comprises the first and second glyphs, or the second glyph is applied to the electronic image of the cheque after the cheque has been imaged.

40-41. (canceled)

42. A method of authenticating a cheque security papers and the like, comprising:
generating a unique identifier for the cheque;
storing the unique identifier;
generating a token having a header and a security section, the header including a first data set including the identifier, the token including a PIN representing an authority to issue the cheque on behalf of an organisation;
converting the token into a character string;
encoding the character string onto a data carrier;
applying the encoded data character to a cheque;
reading data stored in the data carrier from a completed cheque to retrieve the character string from the data carrier;
retrieving the PIN from the character string;
comparing the PIN with a record of at least one PIN corresponding to the organisation issuing the cheque and
rejecting the cheque if the PIN is absent from the character string or the PIN does not match a stored PIN for the organisation issuing the cheque.

43. A method according to claim 42, comprising, if the retrieved PIN matches a record stored for the organisation issuing the cheque,
authenticating the cheque by authenticating a cheque identity derived from the character string against the stored identity.

44. A method according to claim 42, wherein a unique PIN is issued to each authorised signatory in an organisation issuing cheques and a record of authorised signatories and their respective PINs is provided to a cheque authorising party, and wherein the token includes an identification of the signatory to the cheque, comprising:
comparing the signatory and the PIN retrieved from the character string with the stored record, and
rejecting the cheque if the PIN does not match the PIN stored for that signatory.

45. A method according to claim 44, wherein the signatory information is encoded into the token.

46. A method according to claim 42, wherein a unique PIN is issued to each authorised signatory in an organisation issuing cheques and the party authorising the cheque has a store of specimen signatures for each authorised signatory, the specimen signatures being stored with their respective PIN, comprising:
imaging completed cheques to form an image of a signature on the cheque;
retrieving the PIN from the token;
retrieving the stored signature linked to the retrieved PIN;
comparing the imaged signature with the stored signature; and
at least partially authorising the cheque if the stored signature matches the imaged signature.
